(19) United States
(12) Patent Application Publication
(10) Pub. No.: US 2026/0113581 A1
(43) Pub. Date: Apr. 23, 2026

(54) A DOME FOR A PERSONAL AUDIO DEVICE AND A PERSONAL AUDIO DEVICE

(71) Applicant: Sonion Nederland B.V., Hoofddorp (NL)

(72) Inventors: Caspar Titus BOLSMAN, Hoofddorp (NL); Petrus Egbertus Henricus HERMSEN, Hoofddorp (NL); Timea Denisa MERCA, Ballerup (DK); Nikolaj CHRISTIANSEN, Ballerup (DK); Lucas LESUEUR, Ballerup (DK); Amir SHAHAR, Ballerup (DK); Jan JOHANSEN, Ballerup (DK); Daniel Richard DE BARRIE, Hoofddorp (NL)

(73) Assignee: Sonion Nederland B.V., Hoofddorp (NL)

(21) Appl. No.: 19/117,675

(22) PCT Filed: Oct. 11, 2023
(86) PCT No.: PCT/EP2023/078148

§ 371 Date: Apr. 2, 2025

(30) Foreign Application Priority Data
Oct. 11, 2022 (EP) 22200830.2

(51) Int. Cl. H04R 25/00; H04R 1/02; H04R 1/10

(52) U.S. Cl. CPC H04R 25/654; H04R 1/023; H04R 1/1016; H04R 1/1058; H04R 25/60; H04R 2225/025

(57) ABSTRACT

The present disclosure provides a dome for a personal audio device. The dome comprises a central portion defining a channel extending in a longitudinal direction, where a first sound opening is arranged at a first end, and a circumferential member arranged circumferential around the central portion. The circumferential member is attached to the central portion at the first end, and comprises second sound opening at a front end. The central portion is formed by a first material and the circumferential member is formed by a second material, the second material being more flexible than the first material. A first length of the circumferential member in the longitudinal direction is in the range of 25% to less than 100% of a second length of the central portion in the longitudinal direction.

### FIELD OF THE INVENTION

The present invention relates to a dome for a personal audio device; and to a personal audio device comprising a dome. The dome is for positioning in or partly in the ear canal of a user. The dome comprises a central portion and a circumferential member arranged circumferentially around the central portion.

### BACKGROUND OF THE INVENTION

Debris, such as cerumen and moisture can accumulate on personal audio devices causing a variety of problems, such as clogging sound openings and corroding parts. Parts and features of the personal audio device, in particular part and features of speakers (receivers), need to be protected from such debris to prevent any adverse effects.

Traditionally, barriers are used to protect the personal audio device from debris ingress through sound ports. A problem with these barriers is that they eventually soil, which affects the acoustic transmission. The existing solutions require cleaning or replacement of the barrier, but this process tends to be too complicated either because of size or tool requirements. Improper servicing can aggravate the situation taking contaminants to locations where they damage other parts of the personal audio device, which parts may be even more difficult to service.

### DESCRIPTION OF THE INVENTION

It is an object of embodiments of the invention to provide an improved dome for a personal audio device. It is a further object to provide a hearing device comprising an improved dome.

The invention provides a dome for a personal audio device as claimed in claim 1 and a hearing device as claimed in claim 18.

Accordingly, according to a first aspect the present invention relates to a dome comprising:
a central portion defining a channel extending in a longitudinal direction between a first end and an opposite second end, wherein a first sound opening is arranged at the first end, the first sound opening being configured for passage of sound,
a circumferential member arranged circumferentially around the central portion, the circumferential member being attached to the central portion at the first end, and extending in the longitudinal direction between a front end and a rear end, wherein a second sound opening is arranged at the front end, the second sound opening being configured for passage of sound,
a cavity formed along at least a part of an outer surface of the central portion and at least a part of an inner surface of the circumferential member along the longitudinal direction,
a first sound path arranged in the channel, the first sound path being configured for passage of sound from the personal audio device to an ear canal of a user via the first and second sound openings,
wherein the central portion is formed by a first material and the circumferential member is formed by a second material, the second material being more flexible than the first material, and
wherein a first length of the circumferential member from the front end to the rear end in the longitudinal direction is in the range of 25% to less than 100% of a second length of the central portion from the first end to the second end in the longitudinal direction.

In the context of the present invention, the term “personal audio device” covers a transducer, such as receiver (speaker) or a microphone or an element comprising both a receiver and a microphone which may form part of a hearing device, such as a hearing aid, typically of the receiver-in canal type. However, the personal audio device may also be used in hearables, such as consumer accessories, etc.

Sound may be guided from or to the personal audio device (i.e., the receiver/microphone or a combination thereof). Thus, the personal audio device may be or consist essentially of a receiver to generate sound which may be guided out of the first sound opening. Alternatively, or additionally, the personal audio device may be or consist essentially of a microphone which may receive sound being guided into the first sound opening.

The central portion defines a channel extending in a longitudinal direction between a first end and an opposite second end, where a first sound opening is arranged at the first end. The first sound opening is configured for passage of sound. The central portion may be configured to receive at least part of the personal audio device (typically, the receiver), whereby the first sound opening may be configured for passage of sound from the personal audio device. Thus, a first sound path is arranged in the channel, where the first sound path is configured for passage of sound from the personal audio device to an ear canal of a user via the first sound openings.

The central portion may be substantially tube shaped between the first and second ends, where the cross-sectional shape of the central portion may be substantially circular. It should, however, be understood that that the cross-sectional shape in an alternative embodiment may be different, such as oval, formed as a square, a triangle, or having another shape. In a preferred embodiment, sharp angles may be avoided to reduce the risk of injuring the ear canal of a user. The dimension of the cross-sectional shape, such as the diameter, may vary along the longitudinal direction. In one embodiment, the dimension of the cross-sectional shape may, however, be uniform.

The circumferential member is arranged circumferentially around the central portion, where the circumferential member is attached to the central portion at the first end. The circumferential member may e.g., be attached along a line circumferentially around the outer surface of the central portion. Alternatively, or additionally, the circumferential member may be attached at one or more points at the outer surface of the central portion. In one embodiment, the circumferential member may be releasably attached to the central portion.

The circumferential member may additionally be attached to the central portion at the rear end and/or at one or more positions between the front end and the rear end.

The circumferential member extends in the longitudinal direction between a front end and a rear end, where a second sound opening is arranged at the front end. The second sound opening is configured for passage of sound. The first and second sound openings may be arranged transverse to the longitudinal direction and may be aligned or may be arranged so that they at least partly overlap, whereby both the first sound opening and the second sound opening may be configured for passage of sound from the personal audio device. Thus, the first sound path arranged in the channel is configured for passage of sound from the personal audio device (receiver) to an ear canal of a user via the first and second sound openings.

In the context of the present disclosure, the term “longitudinal direction” should be understood as a direction in which the central portion is longest. To facilitate insertion of the dome into an ear canal, the longitudinal direction may substantially equal an insert direction of the dome/personal audio device into the ear canal.

The front and rear ends of the circumferential member define opposite ends of the circumferential member, where the term ‘front’ and ‘rear’ may refer to the insert direction of the dome/personal audio device relative to the ear canal of a user. To facilitate passage of sound from a personal audio device to an ear canal of a user, the first end may be arranged closer to the ear canal than the second end, thus the first end of the central portion be arranged in the area of the front end of the circumferential member.

A cavity is formed along at least a part of an outer surface of the central portion and at least a part of an inner surface of the circumferential member along the longitudinal direction. Due to the cavity, the circumferential member may move relative to the central portion, e.g., during insertion of the dome and/or during removal of the dome from an ear canal of a user. The movement may primarily be in a radial direction transverse to the longitudinal direction, as the circumferential member is attached to the central portion at the first end.

The attachment of the circumferential member to the central portion at the first end may further allow a larger movement of the circumferential member relative to the central portion at the second end than at positions closer to the first end.

The length of the circumferential member from the front end to the rear end in the longitudinal direction is denoted a first length, whereas the length of the central portion from the first end to the second end in the longitudinal direction is denoted a second length. To facilitate insertion of the dome comprising the circumferential member and the central portion, the first length is in the range of 25% up to less than 100% of the second length.

The central portion is formed by a first material and the circumferential member is formed by a second material, where the second material is more flexible than the first material. By providing the circumferential member of a material being more flexible than the first material, it may be achieved, that the outer shape of the circumferential member may change e.g., during insertion into and/or removal of the dome out of an ear canal of a user to facilitate insertion/removal of the dome and/or facilitate adaptation of the outer shape to the inner shape of the ear canal.

Flexibility is related to the amount of force needed to deform a material. It is related to Flexural Modulus, which is the tendency of a material to resist bending. The material that is deformed more easily is said to be more flexible or having a lower flexural modulus. The flexibility may be measured using the Shore A hardness scale, where a higher value specifies a lower flexibility than a lower value. Deformation can be either plastic or elastic. The dome of the present invention, in normal use, should not plastically deform. Thus, both the first and second materials should remain in the elastic deformation range. The first material may have a Shore A hardness of at least 85, whereas the second material may have a lower Shore A hardness, such as in the range of 10-80.

The central portion is provided of a first material being less flexible than the second material. By further providing the central portion of a first material having a Shore A hardness of at least 85, it may be achieved that the shape of the central portion does not substantially change during insertion of the dome comprising the central portion into an ear canal and/or removal, whereby retention of a personal audio device (receiver) inserted into the channel may be facilitated. Additionally, a low flexural modulus of the first material for the central portion may provide protection for the personal audio device when inserted into the channel.

The providing of a central portion of a first material being less flexible than the second material may further provide the advantage that a spout may be omitted from the personal audio device, as the circumferential member can be attached directly to the central portion. In prior art devices a dome element is typically attached to a spout extending from the personal audio device. Consequently, the present disclosure may provide a shorter product compared to prior art products. Accordingly, in a preferred embodiment, the present invention provides a personal audio device in the form of a transducer, such as a speaker (often referred to as a receiver) in a speaker housing with a sound opening in the speaker housing and a dome according to the present invention, wherein the sound opening of the speaker housing acoustically connects with the first sound opening of the central portion of the dome; and wherein the longitudinal distance between the front end of the circumferential member and the sound opening in the speaker housing is typically less than 4 mm.

The first material and/or the second material may be a material which comprises more than one ingredient. The terms first material and second material are not limiting the material to pure materials with no additives or combination of materials. The terms first material and second material specify that the central portion is made of another material than the circumferential member.

It should further be understood that the first and second material may comprise the same ingredients, however in different ratios. As an example, the first material may be plastic material with an additive to make it less flexible, whereas the second material may be the same plastic material, e.g., without the additive or with a smaller amount of the additive or with a different additive to make the second material more flexible than the first material.

The central portion may be made of e.g., metal, ceramic, or plastic, such as different types of metal and/or different types of plastic or harder silicone. Preferably, the central portion is made of a polyamide such as polycaprolactam (Nylon 6), polylaurolactam (Nylon 12) or Nylon 66; polyalkylene terephthalate, such as polyethylene terephthalate (PET) or polybutylene terephthalate (PBT), more preferably polybutylene terephthalate (PBT). The material for the central portion may optionally be glass fibre reinforced, such as with a glass fibre content in the range of up to 30%. The circumferential member may as an example be made of a plastic material, such as silicone or TPE (thermoplastic elastomer), preferably silicone rubber, such as cross-linked or cured liquid silicone rubber (LSR).

The central portion comprises an engagement structure configured for releasably locking the personal audio device to the dome, when inserted into the channel. By locking a personal audio device (such as a receiver) to the central portion of the dome, it may be achieved that the dome and the personal audio device do not separate during insertion, removal, and/or use.

In one embodiment, the engagement structure may be formed by a part of the inner surface of the central portion which may substantially match a part on an outer surface of the personal audio device. By providing the central portion with an inner diameter being slightly smaller than the outer diameter of the personal audio device, the personal audio device may as an example be pressed into the channel and may be kept in place by frictional forces action on the outer surface of the personal audio device, thereby providing a frictional fit or squeeze fit.

Alternatively, or additionally, the engagement structure may be a structural feature arranged at an area of the central portion for engage a personal audio device for locking the personal audio device to the dome, thereby providing a snap-fit locking. The engagement device may be formed integrally with central portion or may alternatively be a separate element subsequently attached to the central portion.

An engagement structure configured for releasably locking may provide the ability of e.g., exchanging the dome and/or for separating the dome and the personal audio device e.g., for maintenance, cleaning, exchange of batteries, etc.

The central portion is configured to accommodate at least 50% of the personal audio device, i.e., the transducer, e.g., a receiver (speaker) or a microphone, in the channel, whereby the central portion may protect a large part of the personal audio device. By accommodating at least 50% should be understood, the at least 50% of the transducer/receiver/microphone in the longitudinal direction may be accommodated in the channel. In one embodiment, the transducer/receiver/microphone may be fully inserted into the channel, whereby the central portion may have a size large enough to accommodate it, where size refers to the length of the central portion/channel in the longitudinal direction. Additionally, insertion of the personal audio device into the channel may be facilitated, as the channel may act as guidance for the personal audio device during insertion. The length of the central portion; i.e., the distance in the longitudinal direction between the first end and the opposite second end may be in the range of 10-18 mm. The personal audio device (the transducer, receiver, microphone) may have a length; i.e. size in the longitudinal direction, being in the range of 8-15 mm.

To facilitate locking of the personal audio device to the dome, the engagement structure may be arranged in the channel. The engagement structure may have a shape matching a shape of a part of an outer surface of the personal audio device for mechanical locking of the personal audio device in the channel. The mechanical locking may be based on direct contact between at least a part of an outer surface of the personal audio device and the engagement structure, whereby the personal audio device may be locked to the dome by mechanical forces, including frictional forces. In an embodiment, where the personal audio device is locked to the dome by frictional forces, the size of the channel transverse to the longitudinal direction may preferably be in the range of 101%-120% of the size of the personal audio device transverse to the longitudinal direction. The inner size of the central portion transverse to the longitudinal may preferably be in the range of 3-7 mm. The personal audio device (the transducer, receiver, microphone) may have an outer size transverse to the longitudinal direction preferably being in the range of 2.5-6 mm, or event smaller in embodiments, where the personal audio device is not locked to the dome by frictional forces.

As an example, the engagement structure may form one or more protrusions on an inner surface of the central portion, i.e., inside the channel. In one embodiment, a protrusion may extend circumferentially along the inner surface, thereby forming an uninterrupted protrusion which at the position of the protrusion decreases the size of the channel transverse to the longitudinal direction. In an alternative embodiment, a decrease of the size of the channel transverse to the longitudinal direction may be achieved by arranging two or more protrusions extending circumferentially along a part of the inner surface in a line. Additionally, protrusions may be arranged at different position along the inner surface of the central portion to decrease the size of the channel transverse to the longitudinal directions at more than one position in the longitudinal direction.

One or more indentations may be arranged on the outer surface of the personal audio device, where the one or more indentations may each have a shape matching the shape of a protrusion on the inner surface of the central portion. It should be understood that in an alternative embodiment, one or more protrusions may be arranged on an outer surface of the personal audio device, whereas one or more indentations may be arranged on the inner surface of the central portion. In a further alternative, one or more protrusions and one or more indentations may be arranged both one the inner surface of the central portion and on the outer surface of the personal audio device. The engagement structure may be arranged closer to the second end than the first end.

A support element may be arranged to support the circumferential member, such as during insertion of the dome into and/or removal of the dome from an ear canal of a user and/or during use of the dome and the personal audio device. The support element may be arranged in the cavity circumferentially around the central portion to support the circumferential member along a portion of an inner surface of the circumferential member between the front end and the rear end. The support element may be attached to a least one of the circumferential member and the central portion.

When arranged between the central portion and the circumferential member, the support element may generate a pressure on the circumferential member to ensure engagement to the ear canal, such as to provide a seal along an outer surface of the circumferential member and the ear canal during use. Furthermore, the support element may prevent or at least considerably reduce the risk of flipping a part of the circumferential member; i.e., turning a part of the circumferential member at the rear end inside out. The support element may be made of a flexible material, such as silicone or TPE (thermoplastic elastomer), to allow the circumferential member to adapt to the shape of ear canal and/or allow the circumferential member to be compressed during insertion and/or removal of the dome.

The dome may additionally or alternatively comprise a barrier member which may be configured to limit ingress of wax into the cavity. The barrier member may be arranged in the cavity circumferentially around the central portion along a portion of an inner surface of the circumferential member between the front end and the rear end. The barrier member may preferably be arranged closer to the rear end than the front end to reduce wax ingress deeper into the cavity, such as be arranged in an area adjacent to the rear end. The barrier member may extend from the central portion to the inner surface of the circumferential member to provide a barrier limiting ingress into the cavity. The barrier member may be attached to a least one of the circumferential member and the central portion. The barrier may allow sound to pass. The barrier member may as an example be made of a foam or a plastic material, such as silicone or TPE. The material may be selected to allow the barrier member to be deformed, when the circumferential member is deformed in response to a pressured exerted on the outer surface of the circumferential member, e.g., during insertion of the dome comprising the central portion and the circumferential member into an ear canal and/or removal of the dome from the ear canal.

The barrier member may in one embodiment possess hydrophobic or oleophobic properties. This may as an example be achieved by coating the barrier member or making the barrier member of a material having hydrophobic or oleophobic properties. The hydrophobic or oleophobic properties may provide a chemical barrier for earwax in addition to the physical barrier.

The barrier member may comprise a plurality of openings/pores to allow sound to pass through the barrier member. Additionally, the openings may facilitate deformation of the barrier member when a pressure is applied to an outer surface of the circumferential member. The barrier member may comprise a plurality of hinderance elements, e.g., a grid, elements extending transverse to the cavity, a layered structure, a foam, etc., as the ingress of wax can be minimised when the transport way for wax is not a straight transport way but changes due to the deviations formed by the hinderance element. Thus, the barrier member may act as a maze with pockets formed by the hindrance elements, which pockets may catch wax and other ingress.

A barrier member in the form of a foam may preferably have an PPI value (pores per inch) in the range 20-120PPI, such as in the range of 70-110PPI with acoustic properties allowing sound to pass. The acoustic properties may be adjusted by adjusting a thickness of the foam in the longitudinal direction and/or by adjusting the density of pores of the foam.

A barrier member in the form of a grid may preferably have a mesh opening size in the range of 30 μm to 1000 μm, such as in the range of 70 μm to 200 μm. Additionally, the percentage openness by area of the barrier member may preferably be in the range 20% to 70%, such as in the range of 40%-60%.

In one embodiment, the dome may comprise a barrier member arranged in the cavity, where the barrier member comprises a first barrier and a second barrier, the first and second barriers each being arranged circumferentially around the central portion and extending transverse to the longitudinal direction from an outer surface of the central portion to an inner surface of the circumferential member, the first and second barriers being arranged longitudinal offset from each other in the cavity, wherein the first barrier comprises a plurality of first ribs extending outwardly from the central portion at a first angle, and the second barrier comprises a plurality of second ribs extending outwardly from the central portion at a second angle, the first and second angle being different from each other.

The first and second barriers may be arranged closer to the rear end than the front end to limit wax ingress deeper into the cavity; i.e., limit the amount of wax which may get into the cavity from the rear end of the circumferential member towards the front end of the circumferential member.

The first and second barriers may be arranged to that they are in contact with each other. As an example, a front side of the first barrier may be in contact with a rear side of the second barrier, where the first barrier is positioned closer to the rear end of the circumferential member than the second barrier, and where the front side and rear side refers to the insert direction of the dome along the longitudinal direction. In an alternative embodiment, a distance may be provided between the first and second barriers, such as a distance of up 1.5 mm.

By the term ‘extending outwardly from the central portion’ should be understood, that a first end of the ribs may either be in direct contact with an outer surface of the central portion or that the first end of the ribs may be attached to a base element which is in contact with the central portion. A second base element may be arranged along the inner surface of the circumferential member. A second end opposite to the first end of the ribs may be attached to the second base element.

The first and/or second ribs may be curve shaped. As an alternative, the first and/or second ribs may be straight, S-shaped, or have another shape with a first end attached to a first base element or the outer surface of the central portion and an opposite second end attached to a second base element or an inner surface of the circumferential member.

In one embodiment, each of the first ribs are identical, and each of the second ribs are identical, where the first and second ribs extend outwardly from the central portion at different angles. In one embodiment, the angles may be arranged in a mirror configuration, e.g., by a first angle being +45 degrees, and a second angle being −45 degrees.

In one embodiment, the first barrier and the second barrier may be substantially identical, where the different angles of the first and second ribs may be achieved by mirroring e.g., the second barrier.

The number of first and second ribs may vary form one barrier member to another to thereby change the size of the opening in the barrier member, where the openings are passages between neighbouring ribs. In one embodiment, the number of first and second ribs may as an example be 16. However, the number of first and second ribs may be in the range of 10-30. The number of ribs also changes the acoustical properties of the barrier member. The number of first and second ribs, the first and second angles, the relative angle between the first and second angles may be varied to vary the trade-off between ingress limitation and acoustic properties.

In one embodiment, the barrier member may form part of the support element, thereby forming an element which may support the circumferential member, and which may additionally limit ingress of wax.

In addition to the first sound opening arranged at the first end, at least one sound aperture may be arranged in the central portion at a distance from the first end, thereby providing at least two openings in the central portion, where both of the at least two openings may be configured for passage of sound. The at least one sound aperture may be configured for passage of sound between the channel and the cavity. The direction of the first sound path; i.e. ; passage via the first sound opening may be substantially in the longitudinal direction, whereas, the direction of the second sound path; i.e., passage via the at least one sound aperture may be transverse to the longitudinal direction.

In one embodiment, a plurality of sound apertures, such as two, such as three, such as four, or even more sound apertures may be arranged in the central portion at a distance from the first end. The distance may be substantially the same for each of the sound apertures, as the plurality of sound apertures may be arranged circumferentially along a line at the central portion, such as radially relative to a centre line extending centrally in the channel in the longitudinal direction. It should, however, be understood that the distance from the first end to at least two sound apertures may be different.

A valve may be arranged in the channel adjected to the personal audio device (the receiver). The valve may be arranged to open and close a sound path through the central portion, which sound path may be arranged to allow external sound to pass from the cavity to the central portion. External sound may be defined as sound not being generated by the personal audio device in the form of a receiver, such as sound from the surroundings.

The at least one sound aperture may be arranged to at least partly overlap with a valve opening in a valve forming part of the personal audio device to allow sound passage between the channel and the cavity via the valve. The valve may form a second sound path configured for passage of sound to and from the ear canal, as sound, such as external sound may be guided via the cavity to the valve, via the at least one valve opening and the at least one sound aperture to the personal audio device, and further from the personal audio device to the ear canal of a user. Thus, the second sound path may be formed from the cavity via the valve to the first sound opening and subsequent to the second sound opening to guide sound, such as external sound, from the cavity to the ear canal of a user.

The valve may comprise an actuation structure allowing opening and closing of the second sound path, whereby it may be possible to exclude/to allow external sound from entering the ear canal of a user, dependent on whether the valve is in the closed or open configuration.

In one embodiment, the valve may be located closer to the first end than the receiver. To facilitate sound generated by the receiver entering the ear canal of a user via the first sound opening, a sound canal may extend through the valve in the longitudinal direction. The first sound path may thereby partly be formed by the sound canal.

A protection element may be arranged at the first sound opening to limit ingress of wax into the channel by providing hinderances which may split the first sound opening into smaller sound openings. The protection element may comprise a grid, e.g., made of metal or of a plastic material, such as a polyamide (PA/Nylon), or a polyalkylene terephthalate such as polyethylene terephthalate (PET), or another polymer. The grid may by a woven grid.

An additional protection element may be arranged adjacent to the protection element, such as at a distance from the protection element in the longitudinal direction to increase protection against wax ingress. In one embodiment, the protection element and additional protection elements may touch each other. Alternatively, the additional protection element may be arranged adjacent to the protection element, e.g., at a distance from the protection element being in the range of 0.1-1.0 mm.

The additional protection element may be attached to the central portion or to the circumferential member.

Additionally, or alternatively, an additional protection element may be arranged at the second sound opening to limit ingress of wax into the cavity. Thus, the dome may comprise a protection element and/or an additional protection element. The additional protection element may comprise a grid, e.g., made of plastic or metal or made of a woven fabric or a woven plastic element. In an alternative embodiment, the additional protection element may comprise a foam, e.g., made of polyurethane.

The protection element and/or the additional protection element may in one embodiment possess hydrophobic or oleophobic properties. This may as an example be achieved by coating the protection element and/or the additional protection element or making the protection element and/or the additional protection element of a material having hydrophobic or oleophobic properties. The hydrophobic or oleophobic properties may provide a chemical barrier for earwax in addition to the physical barrier.

In one embodiment, the protection element may comprise a first grid, and the additional protection element may comprise a second grid, where grid openings/or pore size in the second grid may be larger than grid openings/or pore size of the first grid. As the second grid may be arranged closer to the ear canal than the first grid, the second grid may partly protect the first grid.

A permeability of the additional protection element may be greater than a permeability of the protection element to increase protection closer to the channel. In the context of the present invention, the term ‘permeability’ should be understood is the capacity of the protection element to allow a material, such as ear wax, to pass.

As an example, an additional protection element in the form of a grid may preferably have a mesh opening size in the range of 30 μm to 1000 μm, such as in the range of 70 μm to 200 μm. Additionally, the percentage openness by area of the second grid may preferably be in the range 20% to 70%, such as in the range of 40%-60%. A protection element in the form of a grid may correspondingly have a mesh opening and/or percentage openness being greater.

An additional protection element in the form of a foam may preferably have an PPI value (pores per inch) in the range 20-120PPI, such as in the range of 70-110PPI. The foam would preferably have acoustic properties comparable to a second protection element in the form as a grid as specified above which may be achieved by selecting the thickness of the foam in the longitudinal direction and the density of pores of the foam.

The protection element may be formed integrally with the central portion. This may e.g., be achieved by moulding the central portion and the protection element in one piece.

Alternatively, or additionally, the additional protection element may be formed integrally with the circumferential member. This may e.g., be achieved by moulding the circumferential member and the additional protection element in one piece.

The circumferential member may comprise a collar member, where the collar member may be formed by a wall portion extending from an inner surface of the circumferential member and may extend into the cavity and may terminating in a free end. The collar member, i.e., the outwardly extending wall portion may have a shape matching an outer shape of a part of the central portion for attachment of the circumferential member to the central portion. The collar member may extend parallel to the longitudinal direction to form a space into which the first end of the central portion may be inserted and fixed.

To prevent buckling of the circumferential member, at least one stiffening rib may be arranged along an inner surface of the circumferential member to increase the stiffness of the circumferential member. The at least one stiffening rib may in one embodiment be arranged circumferentially along the inner surface of circumferential member, e.g., in the area of the rear end. The stiffening rib(s) may extend from the inner surface towards the central portion and may terminate in a free end. In an alternative embodiment, the at least one stiffening rib may be arranged along the inner surface extending from an area at the rear end towards the front end substantially in the longitudinal direction. The stiffening rib(s) may be formed integrally with the circumferential member or may alternatively be a separate element subsequently attached to the circumferential member. The stiffening rib(s) may advantageously be may of a flexible material, such as silicone or TPE, e.g., to allow the circumferential member to adapt to the shape of the ear canal and/or to facilitate insertion and/or removal of the dome from the ear canal.

To increase protection of the central portion, at least one connection element may be arranged at the rear end of the circumferential member. The connection element may connect the circumferential member to the central portion. The connection element may as an example be a rib attachable to the outer surface of the central portion. Alternatively, or additionally, the rear end of the circumferential member may be adhesively attached to the outer surface of the central portion, and/or attached by frictional forces.

The circumferential member may be attached to the central portion e.g., by gluing or moulding. The circumferential member and the central portion may be made as two separate elements which may subsequently be attached to each other by use of an adhesive. In an alternative embodiment, the central portion may be made as a separate element. In a subsequent step the circumferential member may be moulded. The moulding step may comprise a simultaneous attachment step whereby the circumferential member may be attached to the central portion in a combined moulding and attachment step.

According to a second aspect, the invention provides a dome for a personal audio device, the dome comprising:
a central portion defining a channel extending in a longitudinal direction between a first end and an opposite second end, wherein a first sound opening is arranged at the first end, the first sound opening being configured for passage of sound,
a circumferential member arranged circumferentially around the central portion, the circumferential member being attached to the central portion at the first end, and extending in the longitudinal direction between a front end and a rear end, wherein a second sound opening is arranged at the front end, the second sound opening being configured for passage of sound,
a cavity formed along at least a part of an outer surface of the central portion and at least a part of an inner surface of the circumferential member along the longitudinal direction,
a first sound path arranged in the channel, the first sound path being configured for passage of sound from the personal audio device to an ear canal of a user via the first and second sound openings,
wherein the central portion is formed by a first material and the circumferential member is formed by a second material, the second material being more flexible than the first material, and
wherein the central portion comprises an engagement structure configured for releasably locking the personal audio device to the dome, when inserted into the channel, the central portion being configured to accommodate at least 50% of the personal audio device in the channel.

It should be understood that a skilled person would readily recognise that any feature described in combination with the first aspect of the invention could also be combined with the second aspect of the invention, and vice versa. The remarks set forth above in relation to the first aspect are therefore equally applicable in relation to the second aspect.

According to a third aspect, the invention provides hearing device comprising a dome according to the first aspect or second aspect and a personal audio device, where the personal audio device is a receiver.

It should be understood that a skilled person would readily recognise that any feature described in combination with the first and second aspects of the invention could also be combined with the third aspect of the invention, and vice versa. The remarks set forth above in relation to the first and second aspects are therefore equally applicable in relation to the third aspect.

According to a fourth aspect, the invention provides a dome for a personal audio device, the dome comprising:
a central portion defining a channel extending in a longitudinal direction between a first end and an opposite second end, wherein a first sound opening is arranged at the first end, the first sound opening being configured for passage of sound,
a circumferential member arranged circumferentially around the central portion, the circumferential member being attached to the central portion at the first end, and extending in the longitudinal direction between a front end and a rear end, wherein a second sound opening is arranged at the front end, the second sound opening being configured for passage of sound,
a cavity formed along at least a part of an outer surface of the central portion and at least a part of an inner surface of the circumferential member along the longitudinal direction,
a first sound path arranged in the channel, the first sound path being configured for passage of sound from the personal audio device to an ear canal of a user via the first and second sound openings,
wherein the central portion is formed by a first material and the circumferential member is formed by a second material, the second material being more flexible than the first material, and
wherein a barrier member is arranged in the cavity, where the barrier member comprises a first barrier and a second barrier, the first and second barriers each being arranged circumferentially around the central portion and extending transverse to the longitudinal direction from an outer surface of the central portion to an inner surface of the circumferential member, the first and second barriers being arranged longitudinally offset from each other in the cavity, wherein the first barrier comprises a plurality of first ribs extending outwardly from the central portion at a first angle, and the second barrier comprises a plurality of second ribs extending outwardly from the central portion at a second angle, the first and second angle being different from each other.

The first and second barriers may be arranged closer to the rear end than the front end to limit wax ingress deeper into the cavity. The first and second barriers may be arranged in contact with each other. The first and/or second ribs may be curve shaped. The first barrier and the second barrier may be substantially identical, where the position of the second barrier is mirrored relative to the first barrier.

It should be understood that a skilled person would readily recognise that any feature described in combination with the first, second, and third aspects of the invention could also be combined with the fourth aspect of the invention, and vice versa. The remarks set forth above in relation to the first, second, and third aspects are therefore equally applicable in relation to the fourth aspect.

### BRIEF DESCRIPTION OF THE DRAWINGS

Embodiments of the disclosure will now be further described with reference to the drawings, in which:

FIGS. 1A and 1B illustrate cross-sections through a dome according to the disclosure;

FIG. 2 illustrates different views of a dome and a personal audio device;

FIGS. 3A and 3B illustrate cross-sections through a dome and a personal audio device;

FIG. 3C illustrates a prior art dome;

FIG. 4 illustrates different views of a dome and a personal audio device;

FIGS. 5A and 5B illustrate cross-sections through a dome and a personal audio device;

FIG. 6 illustrates a cross-section through a dome and a personal audio device;

FIGS. 7A-7D illustrate cross-sections through a dome;

FIG. 8 illustrates different views of a dome and a personal audio device, the dome comprising a barrier member;

FIG. 9 illustrates different views of a dome and a personal audio device, the dome comprising support element;

FIG. 10 illustrates different views of a dome and a personal audio device, the dome comprising a barrier member;

FIG. 11 illustrates different views of a dome and a personal audio device, the dome comprising a barrier member;

FIG. 12 illustrates different views of a dome and a personal audio device, the dome comprising a barrier member;

FIG. 13 illustrates different views of a dome and a personal audio device, the dome comprising a support element;

FIG. 14 illustrates different views of a dome and a personal audio device, the dome comprising a support element;

FIG. 15 illustrates different views of a dome and a personal audio device, the dome comprising a barrier member;

FIG. 16 illustrates different views of a dome and a personal audio device;

FIG. 17 illustrates different views of a dome and a personal audio device, the dome comprising a support element;

FIG. 18 illustrates different views of a dome and a personal audio device, the dome comprising a barrier member;

FIG. 19 illustrates different views of a dome and a personal audio device, the dome comprising a barrier member;

FIGS. 20A-20D illustrate different views of a dome and a personal audio device, the dome comprising a barrier member;

FIGS. 21A-21C illustrate different embodiments of a dome comprising one or more stiffening ribs;

FIG. 22 illustrates different views of a dome and a personal audio device;

FIG. 23 illustrates a cross-section of a dome;

FIGS. 24A-24F illustrate different views of a dome and a personal audio device; and

FIGS. 25A-25G illustrate different views of a dome and a personal audio device.

### DETAILED DESCRIPTION OF THE DRAWINGS

It should be understood that the detailed description and specific examples, while indicating embodiments of the disclosure, are given by way of illustration only, since various changes and modifications within the scope of the disclosure will become apparent to those skilled in the art from this detailed description. Throughout the description of the drawings the personal audio device is a transducer which may preferably be a receiver (also denoted a speaker).

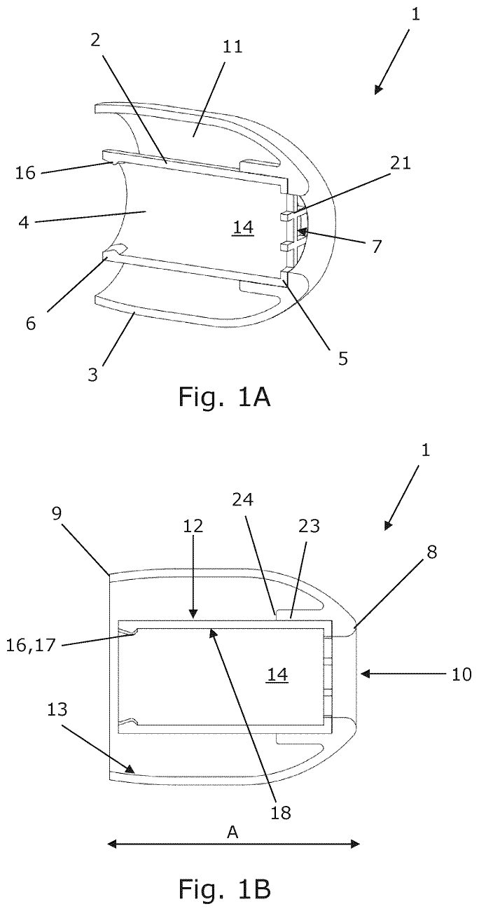

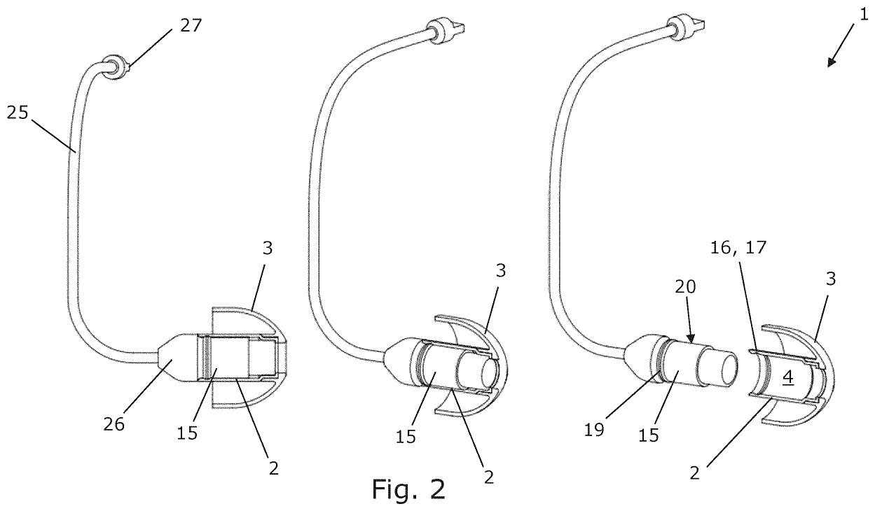

FIGS. 1A and 1B illustrate cross-sections through a dome 1. The dome 1 comprises a central portion 2 and a circumferential member 3. The central portion 2 defines a channel 4 extending in a longitudinal direction (indicated by the arrow A) between a first end 5 and an opposite second end 6. A first sound opening 7 is arranged at the first end 5, where the first sound opening 7 is configured for passage of sound.

The circumferential member 3 is arranged circumferentially around the central portion 2, and the circumferential member 3 is attached to the central portion 2 at the first end 5. The circumferential member 3 extends in the longitudinal direction between a front end 8 and a rear end 9. A second sound opening 10 configured for passage of sound is arranged at the front end 8.

A cavity 11 is formed along at least a part of an outer surface 12 of the central portion 2 and at least a part of an inner surface 13 of the circumferential member 3 along the longitudinal direction. The cavity 11 extends circumferentially around a part of the central portion 2.

The central portion 2 defines a channel 4. A first sound path 14 is arranged in the channel 4, where the first sound path 14 is configured for passage of sound from a personal audio device 15 (see FIG. 2) which may be arranged at least partly in the channel 4, to an ear canal of a user (not shown) via the first and second sound openings 7, 10. In the illustrated embodiment, the first and the second sound openings 7, 10 are aligned, thereby facilitating sound propagating from the channel 4 to an ear canal of a user via the first and second sound openings 7, 10.

The central portion 2 is formed by a first material and the circumferential member 3 is formed by a second material, where the second material is more flexible than the first material to allow deformation of the circumferential member 3, e.g., during insertion and/or removal. The central portion 2 may form a protecting shield for the personal audio device in the form of a transducer (receiver and/or microphone) at least partly inserted into the channel 4. Due to the cavity 11 and the flexibility of the second material, at least a part of the circumferential member 3 may move relative to the central portion 2, which movement may facilitate insertion of the dome 3 into an ear canal and/or removal of the dome 3 from the ear canal.

The central portion 2 comprises an engagement structure 16 configured for releasably locking the personal audio device 15 to the dome 1, when inserted into the channel 4. The central portion 2 is configured to accommodate at least 50% of the personal audio device 15 in the channel 3 in the longitudinal direction. In the illustrated embodiment, the engagement structure 16 comprises a protrusion 17 on the inner surface 18 of the central portion 2. The protrusion 17 extends circumferentially along the inner surface 18 to form an uninterrupted protrusion which at the position of the protrusion 17 decreases the size of the channel 2 transverse to the longitudinal direction. An indentation 19 (see FIG. 2) is arranged on the outer surface 20 of the personal audio device 15. The indentation 19 has a shape matching the shape of the protrusion 17 on the inner surface 18 of the central portion 2.

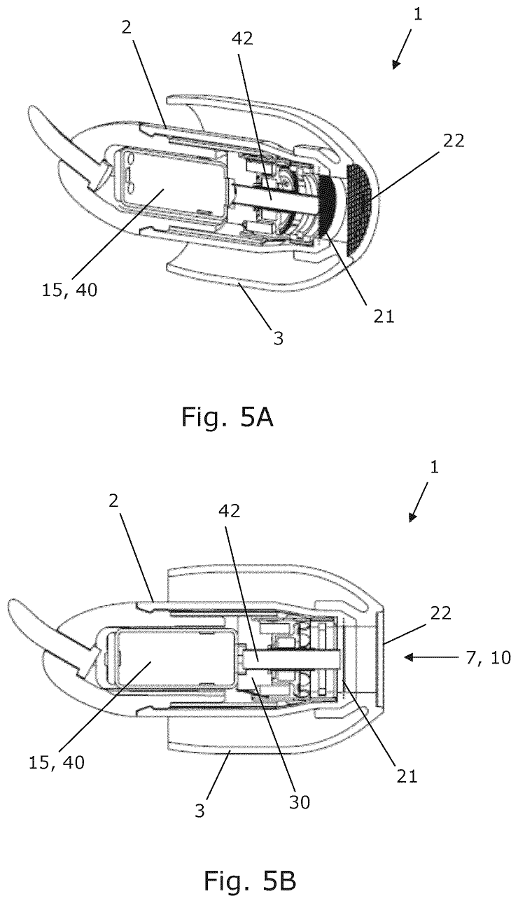

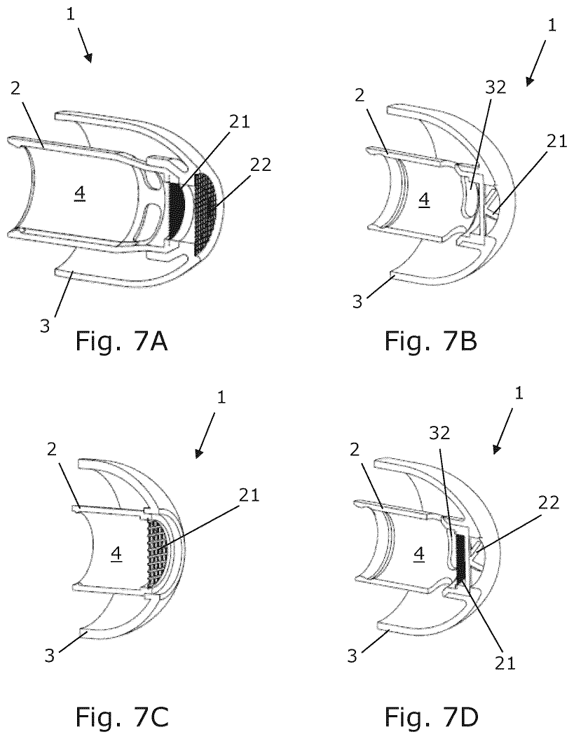

A protection element 21 to limit ingress of wax into the channel 4 is arranged at the first sound opening 7. In the illustrated embodiment, the protection element 21 comprises a grid 21. An additional protection element 22 (see e.g., FIG. 5A and FIG. 7A) may additionally be arranged at the second sound opening 10 to limit ingress of wax into the cavity 11. The embodiment illustrated in FIGS. 1A and 1B does not comprise an additional protection element.

The circumferential member 3 comprises a collar member 23 which extends into the cavity 11 and terminates in a free end 24. The collar member 23 has a shape matching a part of the outer surface 12 of the central portion 2 for attachment of the circumferential member 3 to the central portion 2. The collar member 3 extends substantially parallel to the longitudinal direction to form a space into which the first end 5 of the central portion 2 is inserted and fixed. The central portion 2 may be kept in place by frictional forces acting between the collar member 23 and the central portion 2 or may alternatively or additionally be adhesively attached.

The following figures illustrate different embodiments of a dome 1. The above applied reference numbers refer to the same features in the following description of the different embodiment. Each of the embodiments of the dome 1 comprises a central portion 2 and a circumferential member 3, where the central portion 2 defines a channel 4 extending in a longitudinal direction between a first end 5 and an opposite second end 6. A first sound opening 7 configured for passage of sound is arranged at the first end 5.

The circumferential member 3 is arranged circumferentially around the central portion 2, and the circumferential member 3 is attached to the central portion 2 at the first end 6. The circumferential member 3 extends in the longitudinal direction between a front end 8 and a rear end 9. A second sound opening 10 configured for passage of sound is arranged at the front end 8.

A cavity 11 is formed along at least a part of an outer surface 12 of the central portion 4 and at least a part of an inner surface 13 of the circumferential member 3.

A first sound path 14 is arranged in the channel 4, where the first sound path 14 is configured for passage of sound from a personal audio device 15 in the form of a transducer (receiver and/or microphone) via the first and second sound openings 7, 10.

The central portion 2 comprises an engagement structure 16 configured for releasably locking the personal audio device 15 to the dome 1, when inserted into the channel 4.

The length of the circumferential member 3 from the front end 8 to the rear end 9 in the longitudinal direction is denoted a first length, whereas the length of the central portion 2 from the first end 5 to the second end 6 in the longitudinal direction is denoted a second length. To facilitate insertion of the dome 1 comprising the circumferential member 3 and the central portion 2, the first length is in the range of 25% up to less than 100% of the second length.

FIG. 2 illustrates different sectional views of a dome 1 and a personal audio device 15 in the form of a receiver. In the left part of FIG. 2, the personal audio device 15 is inserted into the channel 4 which is visible in the right part of FIG. 2, where the personal audio device 15 is not attached to the dome 1. The engagement structure in the form of the protrusion 17 engages the indentation 19 to releasably lock the personal audio device 15 to the dome 1.

The personal audio device 15 is connected to a tube 25 by a first connector 26 being connected to the personal audio device 15. At the opposite end of the tube a second connector 27 is arranged enabling attachment of the tube e.g., to a behind-the-ear-part (not shown).

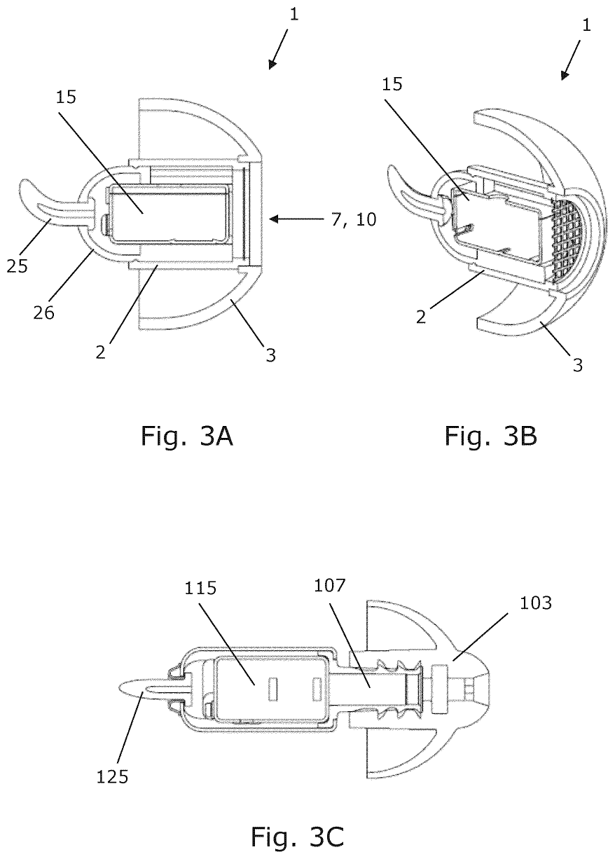

FIGS. 3A and 3B illustrate cross-sections through the dome 1 and the personal audio device 15 also illustrated in FIG. 2 with more details. As the sound output opening (not shown) of the personal audio device 15 may be arranged close to the first sound opening 7, the first audio device 15 may be without a spout, whereby the overall size (the length in the longitudinal direction) may be smaller compared to a traditional device. An example of a prior art audio device 115 comprising a spout 107 is illustrated in FIG. 3C, where a prior art dome element 103 is attached to the spout 107 extending from the prior art audio device 115.

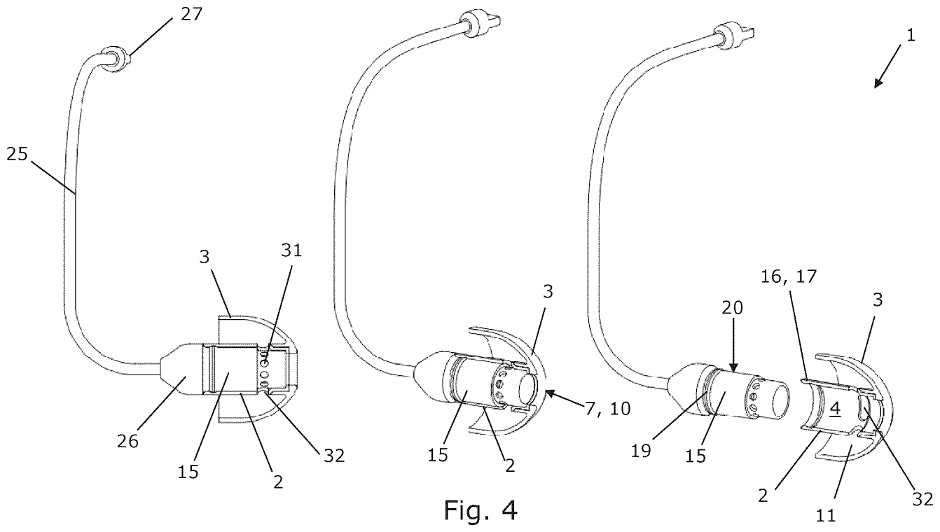

FIG. 4 illustrates different sectional views of a dome 1 and a personal audio device 15. In the left part of FIG. 4, the personal audio device 15 is inserted into the channel 4 which is visible in the right part of FIG. 4. The engagement structure in the form of the protrusion 17 engages the indentation 19 to releasably lock the personal audio device 15 to the dome 1.

The personal audio device 15 is connected to a tube 25 by a first connector 26 being connected to the personal audio device 15. At the opposite end of the tube a second connector 27 is arranged enabling attachment of the tube e.g., to a behind-the-ear-part (not shown).

A valve 30 is arranged adjacent to the personal audio device 15 in the channel 4. The valve 30 is arranged to open and close a sound path (not shown) form the cavity 11 to the channel 4. The sound path is arranged to allow external sound to pass to the personal audio device in the channel. The valve 30 comprises a plurality of valve openings 31. The valve openings 31 are in the illustrated embodiment arranged transverse to the longitudinal direction.

A plurality of sound apertures 32 are arranged in the central portion 2 (see right part of FIG. 4) at a distance from the first end 5, thereby providing additional openings in the central portion 2, where the sound apertures 32 are configured for passage of sound between the channel 4 and the cavity 11.

The sound apertures 32 are arranged to at least partly overlap with the valve openings 31 to allow sound passage between the channel 4 and the cavity 11 via the valve 30. The valve 30 thereby forms a second sound path configured for passage of sound to and from the ear canal, as sound, such as external sound may be guided from the cavity 11 to the valve 30 via the valve openings 31 and the sound apertures 32, and further from the valve 30 to the ear canal of a user via the first and second sound opening 7, 10.

FIGS. 5A and 5B illustrate cross-sections through the dome 1 and the personal audio device 15 also illustrated in FIG. 4 with more details. The additional protection element 22 arranged at the second sound opening 10 to limit ingress of wax into the cavity 11 is also illustrated.

In the illustrated embodiment, the valve 30 is located closer to the first end than a receiver 40 forming the personal audio device 15. To facilitate sound generated by the receiver 40 entering the ear canal of a user via the first sound opening 7, a sound canal 42 extends through the valve 30 in the longitudinal direction.

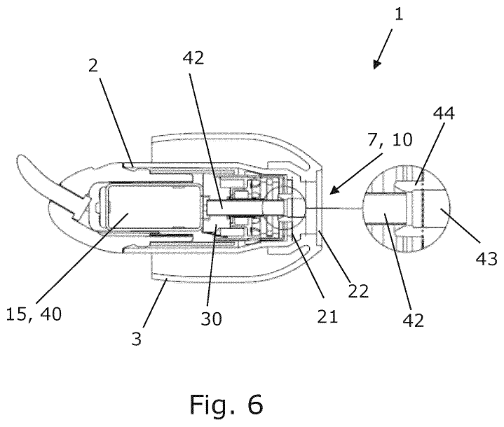

FIG. 6 illustrates a cross-section through a dome 1 and a personal audio device 15. The illustrated embodiment is similar to the embodiment illustrated in FIGS. 5A and 5B with the exception that an additional sound canal 43 is arranged to extend through the first sound opening 7 and the protection element 21. At the protection element 21, a protective collar 44 is arranged to minimise the risk of sound leakage from the personal audio device 15, when sound is lead via the sound canal 42 to the additional sound canal 43, as the free end of the sound canal 42 is arranged in the protective collar 44.

FIGS. 7A-7D illustrate cross-sections through different embodiments of a dome 1. Each of the embodiments of the dome 1 comprises a central portion 2 and a circumferential member 3, where the central portion 2 defines a channel 4 in which a personal audio device (not shown) may be inserted and releasably locked to the dome 1.

FIGS. 7A, 7B, and 7D illustrate the sound apertures 32 arranged in the central portion 2 to allow sound to pass from the cavity 11 to the channel 4.

The dome 1 in FIG. 7A comprises a protection element 21 and an additional protection element 22, both in the form of a grid, whereas the dome 1 in FIG. 7C only comprises one protection element 21 in the form of a grid, however with different grid size.

The dome 1 illustrated in FIG. 7B comprises a protection element 21 in the form of a coarse filter, whereas the dome illustrated in 7D comprises a protection element 21 in the form of a grid and an additional protection element 22 in the form of a coarse filter, where the bars constituting the filter are moulded together with the central portion.

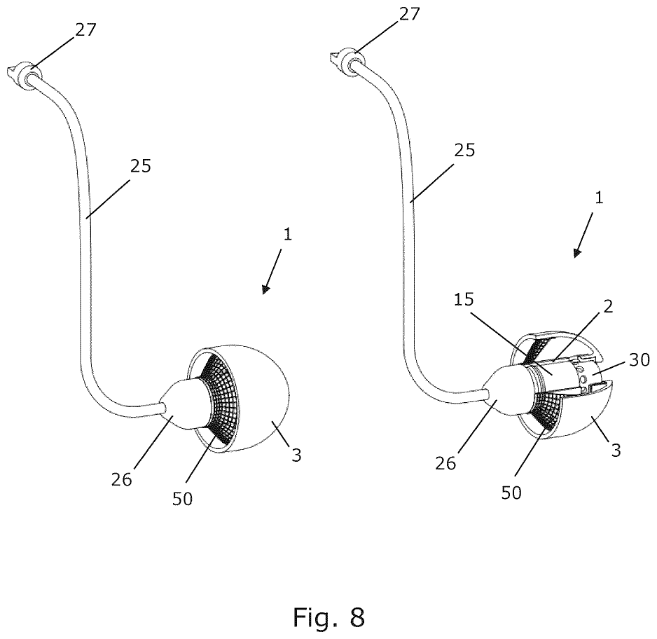

FIG. 8 illustrates different views of a dome 1 comprising a valve and a personal audio device 15 in the form of a receiver. The dome 1 comprises a barrier member 50 which is arranged in the cavity 11 closer to the rear end of the circumferential member than the front end thereof. The barrier member 50 extends circumferentially around the central portion 2 from the outer surface 12 of the central portion 2 to the inner surface 13 of the circumferential member. The barrier member 50 is configured to limit ingress of wax into the cavity 11.

In the illustrated embodiment, the barrier member 50 comprises a grid made of a woven polymer. The grid 50 is flexible to allow the circumferential member 3 to be compressed to fit the inner surface of the ear canal when inserted.

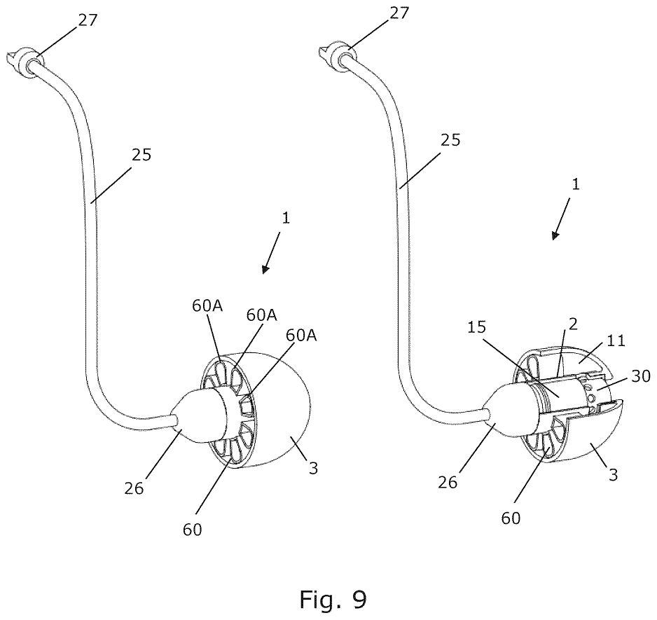

FIG. 9 illustrates different views of a dome 1 comprising a valve and a personal audio device 15 in the form of a receiver. The dome 1 comprises a support element 60 which is arranged in the cavity 11 closer to the rear end of the circumferential member than the front end hereof. The support element 60 extends circumferentially around the central portion 2 from the outer surface 12 of the central portion 2 to the inner surface 13 of the circumferential member.

The support element 60 is arranged to generate a pressure on the inner surface of the circumferential member 3 to ensure engagement of the outer surface of the circumferential member 3 to the ear canal. Furthermore, the support element 60 may prevent that a part of the circumferential member 3; i.e., the part at the rear end, is turned inside out.

In the illustrated embodiment, the support element 60 comprises a plurality of U-shaped protrusions 60A made of a soft material, such a silicone, to allow movement of the support element 60 relative to the central portion 2. The number of U-shaped protrusions 60A may be different in an alternative embodiment. The support element 60 may, as an example, comprise two protrusions, three protrusions, four protrusions, or even more protrusions, such as 10, 11, 12, or more.

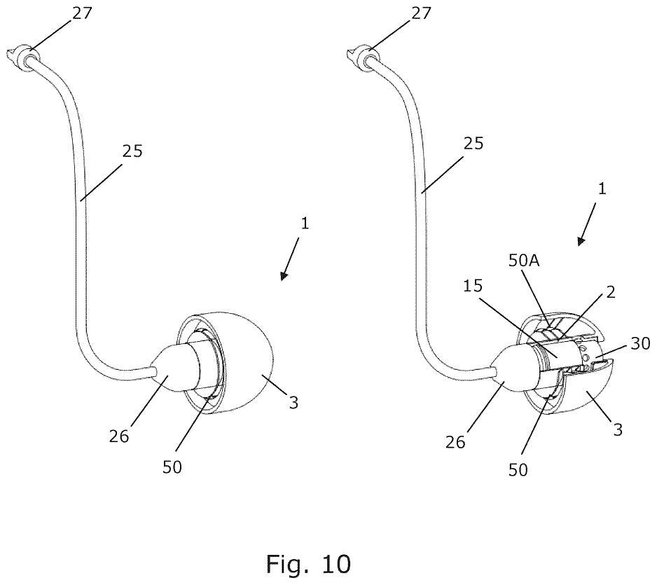

FIG. 10 illustrates different views of a dome 1 comprising a valve 30 and a personal audio device 15 in the form of a receiver. The dome 1 comprises a barrier member 50 which is arranged in the cavity 11. The barrier member 50 is configured to limit ingress of wax into the cavity 11.

In the illustrated embodiment, the barrier member 50 comprises a plurality of rib members 50A, where a set of first rib members 50A extends circumferentially around the central portion 2 from the outer surface 12 of the central portion 2 toward the circumferential member 3, and a set of second rib members 50A extends from the inner surface of the circumferential member 3 towards the central portion 2. By arranging the rib members 50A from the first and second set alternating along the longitudinal direction, an opening into the cavity 11 is partly hindered by the barrier member, thereby reducing the risk of wax ingress.

In the illustrated embodiment, the first and second sets of rib members 50A extend substantially perpendicular to the longitudinal direction. It should, however, be understood that at least some of the rib members may be arranged at a different angle; i.e., not perpendicular to the longitudinal direction. The number of rib members may also vary.

The dome 1 illustrated in FIG. 10 comprises both a set of first rib members and a set of second rib members. In an alternative embodiment, only a set of first rib members or only a set of second rib members may be applied.

The rib members 50a may be made of a flexible material, such as silicone or TPU.

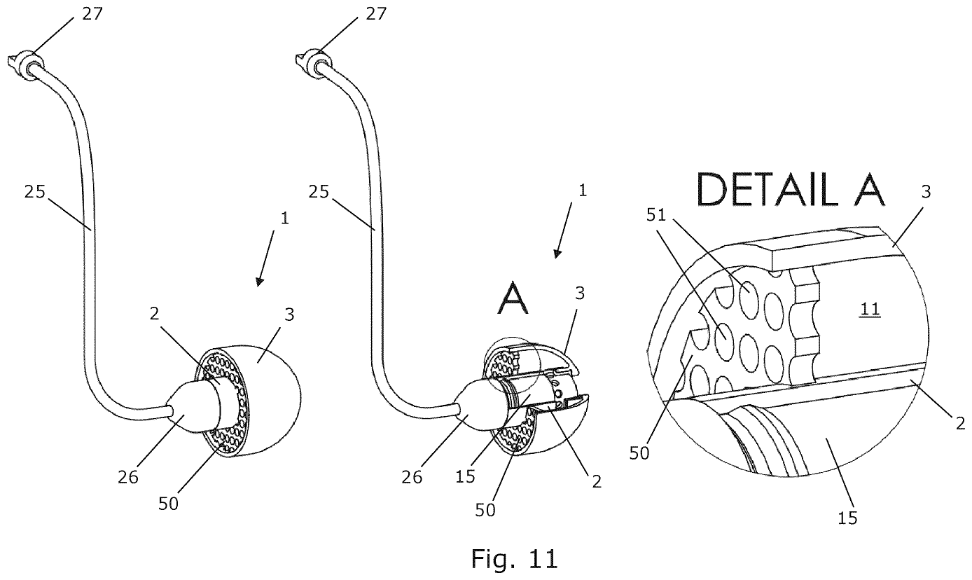

FIG. 11 illustrates different views of a dome 1 comprising a valve 30 and a personal audio device 15 in the form of a receiver. The dome 1 comprises a barrier member 50 which is arranged in the cavity 11 closer to the rear end of the circumferential member than the front end hereof. The barrier member 50 extends circumferentially around the central portion 2 from the outer surface 12 of the central portion 2 to the inner surface 13 of the circumferential member. The barrier member 50 is configured to limit ingress of wax into the cavity 11.

In the illustrated embodiment, the barrier member 50 comprises disk-shaped element 50 of a flexible material. The disk-shaped element 50 comprises a plurality of small through-holes 51. As the barrier member 50 is flexible, it allows the circumferential member 3 to be compressed when inserted, and further the barrier member 50 acts as a support element generating a pressure on the inner surface of the circumferential member 3 to ensure engagement of the outer surface of the circumferential member 3 to the ear canal.

Detail A (to the right in FIG. 11) illustrates the small through-holes 51 in expanded view. The through holes 51 allow sound to pass from the exterior to the cavity 11.

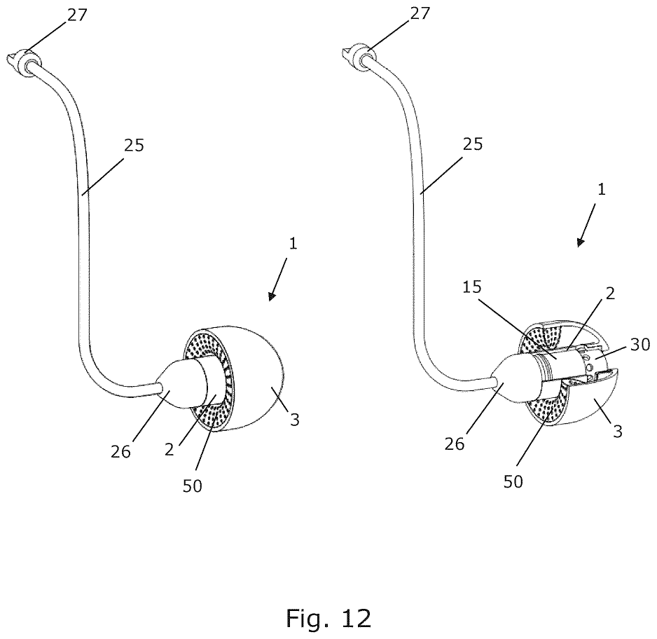

FIG. 12 illustrates different views of a dome 1 comprising a valve 30 and a personal audio device 15 in the form of a receiver. The dome 1 comprises a barrier member 50 which is arranged in the cavity 11.

In the illustrated embodiment, the barrier member 50 comprises disk-shaped double layered element 50 of a flexible material. The barrier member 50 extends circumferentially around the central portion 2 from the inner surface 13 of the circumferential member to the outer surface 12 of the central portion 2 and back to the inner surface 13 of the circumferential member. The double layered disk-shaped element 50 comprises a plurality of small through-holes. By providing a double layered structure, the barrier member 50 provides increased protection again ingress of wax to the cavity 11.

As the barrier member 50 is flexible, it allows the circumferential member 3 to be compressed when inserted, and further the barrier member 50 acts as a support element generating a pressure on the inner surface of the circumferential member 3 to ensure engagement of the outer surface of the circumferential member 3 to the ear canal.

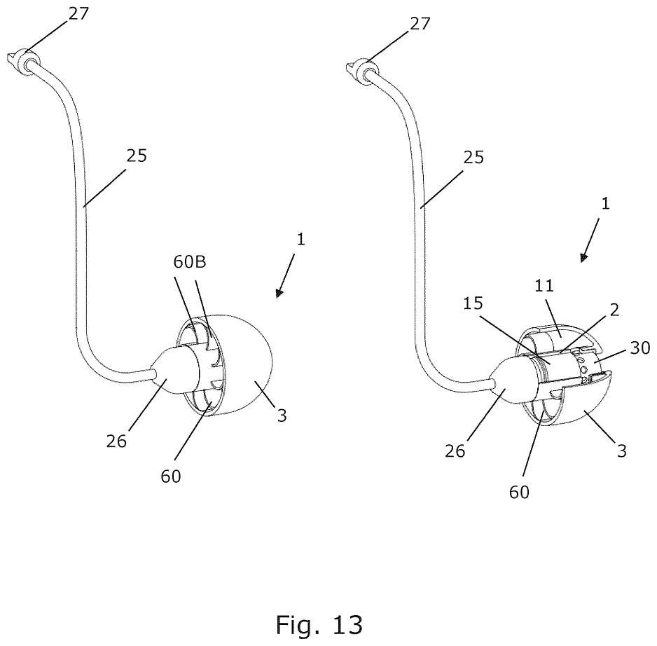

FIG. 13 illustrates different views of a dome 1 comprising a valve 30 and a personal audio device 15 in the form of a receiver. The dome 1 comprises a support element 60 which is arranged in the cavity 11.

The support element 60 is arranged to generate a pressure on the inner surface of the circumferential member 3 to ensure engagement of the outer surface of the circumferential member 3 to the ear canal. Furthermore, the support element 60 may prevent that a part of the circumferential member 3; i.e., the part at the rear end, is turned inside out.

In the illustrated embodiment, the support element 60 comprises a plurality of curved fins/ribs 60A made of a flexible/semi-flexible material to allow movement of the circumferential member 3 relative to the central portion 2. The curved fins 60A are attached to the inner surface of the circumferential member 3 and the outer surface of the central portion 2 at opposite ends of the fins/ribs. Due to the curved shape of the fins 60A, the shape of the circumferential member 3 can be changed during insertion dome 1 into an ear canal.

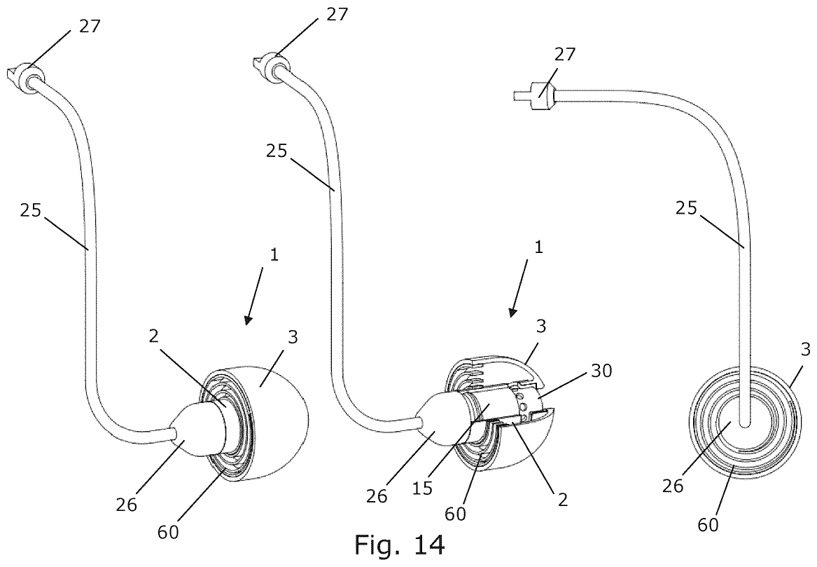

FIG. 14 illustrates different views of a dome 1 comprising a valve 30 and a personal audio device 15 in the form of a receiver. The dome 1 comprises a support element 60 which is arranged in the cavity 11.

The support element 60 is arranged to generate a pressure on the inner surface of the circumferential member 3 to ensure engagement of the outer surface of the circumferential member 3 to the ear canal. Furthermore, the support element 60 may prevent that a part of the circumferential member 3; i.e., the part at the rear end, is turned inside out.

In the illustrated embodiment, the support element 60 comprises a helical element 60 which is attached to the inner surface of the circumferential member 3 at one end and to the outer surface of the central portion 2 at the other end. The helical element 60 is made of a rigid/semi-flexible material to allow compression thereof. Movement of the circumferential member 3 relative to the central portion 2 is possible due to the helical shape of the support element 60.

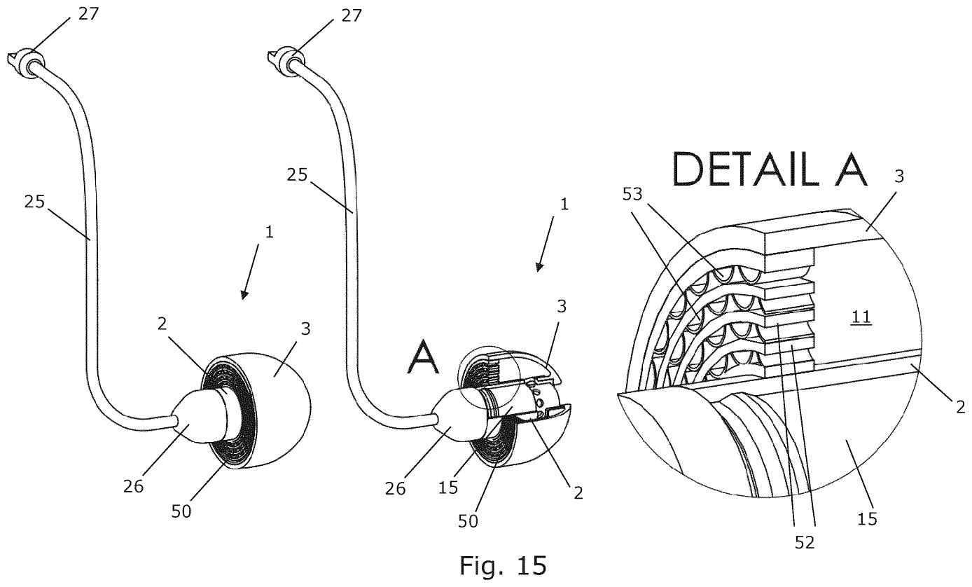

FIG. 15 illustrates different views of a dome 1 comprising a valve 30 and a personal audio device 15 in the form of receiver. The dome 1 comprises a barrier member 50 which is arranged in the cavity 11.

In the illustrated embodiment, the barrier member 50 is formed by a filter comprising a plurality of layered elements 52 to provide protection against ingress of wax into the cavity 11. The barrier member 50 extends circumferentially around the central portion 2 from the inner surface 13 of the circumferential member to the outer surface 12 of the central portion 2.

The layered elements 52 comprise deformable cavities 53 to allow deformation of the barrier member 50, thereby allowing the circumferential member 3 to be compressed when inserted. Consequently, the barrier member 50 further acts as a support element generating a pressure on the inner surface of the circumferential member 3 to ensure engagement of the outer surface of the circumferential member 3 to the ear canal.

Detail A (to the right in FIG. 15) illustrates the layered elements 52 with deformable cavities 53 in expanded view.

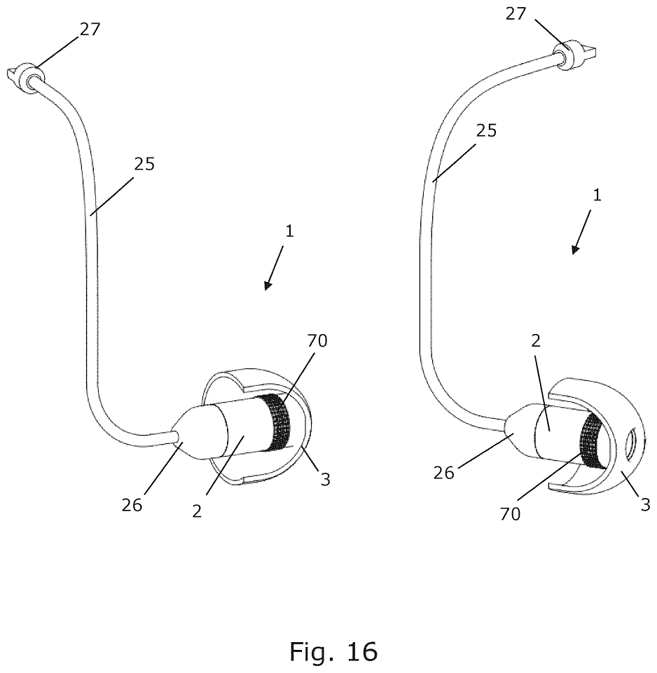

FIG. 16 illustrates different views of a dome 1 comprising a valve 30 and a personal audio device 15 in the form of a receiver. The dome 1 comprises protection element 70 arranged circumferentially around the central portion 2 at the position of the sound aperture 32 (see FIGS. 4, 7A and 7B) to prevent wax ingress from entering the valve 30 (not shown) via the sound apertures 32 (not shown). In the illustrated embodiment, the protection element 70 comprises a woven grid based, e.g., of a polymer. In an alternative embodiment, the protective element may be in the form of foam.

FIG. 17 illustrates different views of a dome 1 comprising a valve 30 and a personal audio device 15 in the form of a receiver. The dome 1 comprises a barrier member 50 which is arranged in the cavity 11.

In the illustrated embodiment, the barrier member 50 is foam which is adhesively attached to the inner surface of the circumferential member 3 and the central portion 2. The foam 50 extends circumferentially around the central portion 2 from the inner surface 13 of the circumferential member to the outer surface 12 of the central portion 2.

The foam 50 provides a barrier for wax ingress protection as well prevents that a part of the circumferential member 3; i.e., the part at the rear end, is turned inside out. The foam can vary in thickness, material, and density (PPI) from one embodiment to another.

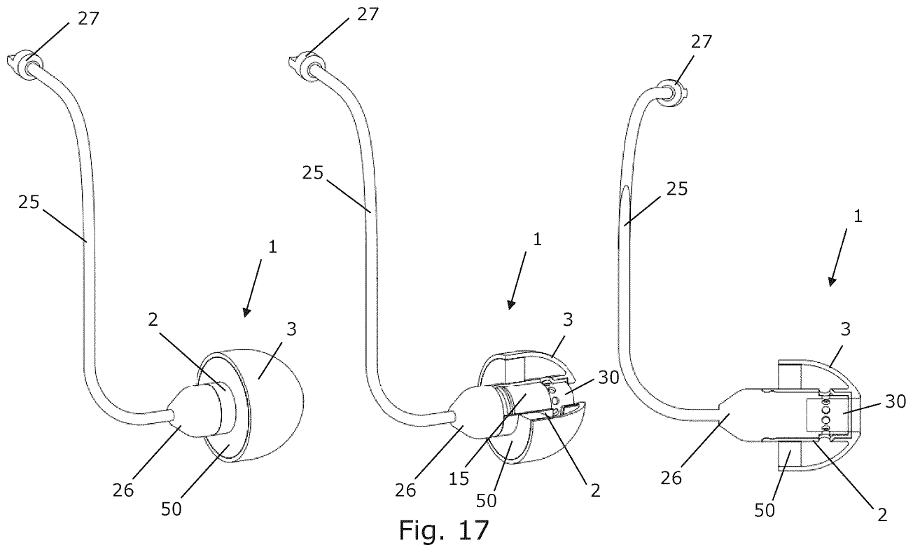

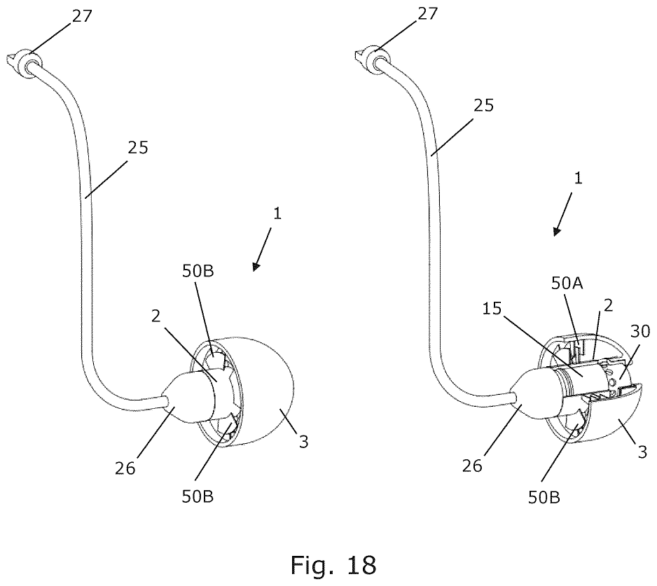

FIG. 18 illustrates different views of a dome 1 comprising a valve 30 and a personal audio device 15. The dome 1 comprises a barrier member 50 which is arranged in the cavity 11. The barrier member 50 is configured to limit ingress of wax into the cavity 11.

In the illustrated embodiment, the barrier member 50 comprises a plurality of rib members 50A, 50B, where a set of first rib members 50B extends from the outer surface 12 of the central portion 2 toward the circumferential member 3, and a set of second rib members 50A extends from the inner surface of the circumferential member 3 towards the central portion 2. By arranging the rib members 50B from the first and second set alternating along the longitudinal direction, an opening into the cavity 11 is partly hindered by the barrier path, thereby reducing the risk of wax ingress. The rib members 50B are similar to the rib members 50A illustrated in FIG. 10 with the exception that the rib members 50B only extend along a part of the inner surface 13 and the outer surface 12, respectively.

In the illustrated embodiment, the first and second sets of rib members 50B extend substantially perpendicular to the longitudinal direction. It should, however, be understood that at least some of the rib members may be arranged at a different angle; i.e., not perpendicular to the longitudinal direction. The number of rib members may also vary.

The dome 1 illustrated in FIG. 18 comprises both a set of first rib members and a set of second rib members. In an alternative embodiment, only a set of first rib members or only a set of second rib members may be applied.

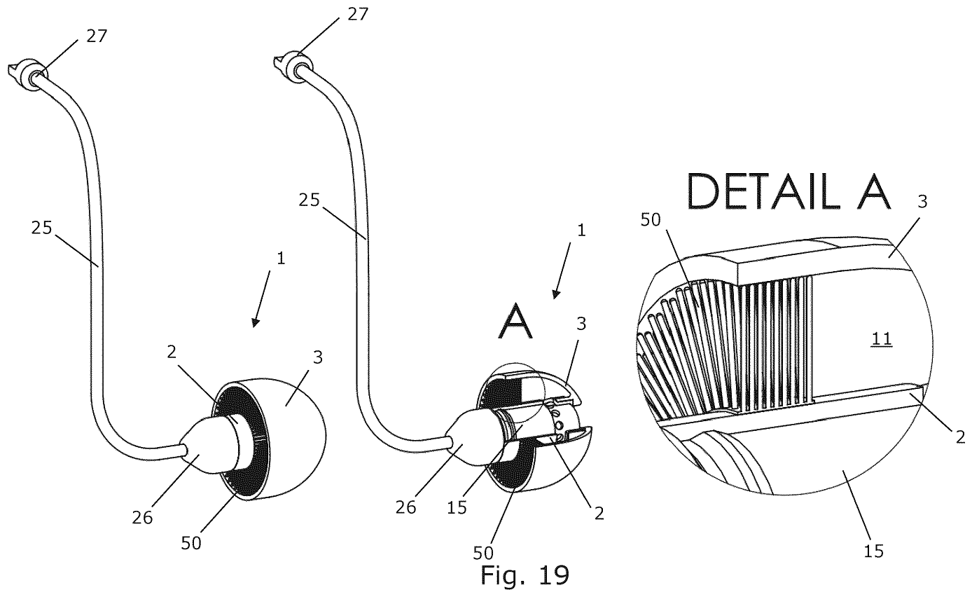

FIG. 19 illustrates different views of a dome 1 comprising a valve 30 and a personal audio device 15. The dome 1 comprises a barrier member 50 which is arranged in the cavity 11.

In the illustrated embodiment, the barrier member 50 comprises a fibre element which is adhesively attached to the inner surface of the circumferential member 3 and the central portion 2. The fibre element 50 comprises a plurality of fibres, e.g., made of silicone, being attached to each other to provide a fibre element. The fibre element 50 extends circumferentially around the central portion 2 from the inner surface 13 of the circumferential member to the outer surface 12 of the central portion 2.

The barrier member 50 provides a barrier for wax ingress protection. The soft/flexible fibres allow deformation of the circumferential member 3.

Detail A (to the right in FIG. 19) illustrates the fibre element 50 in expanded view.

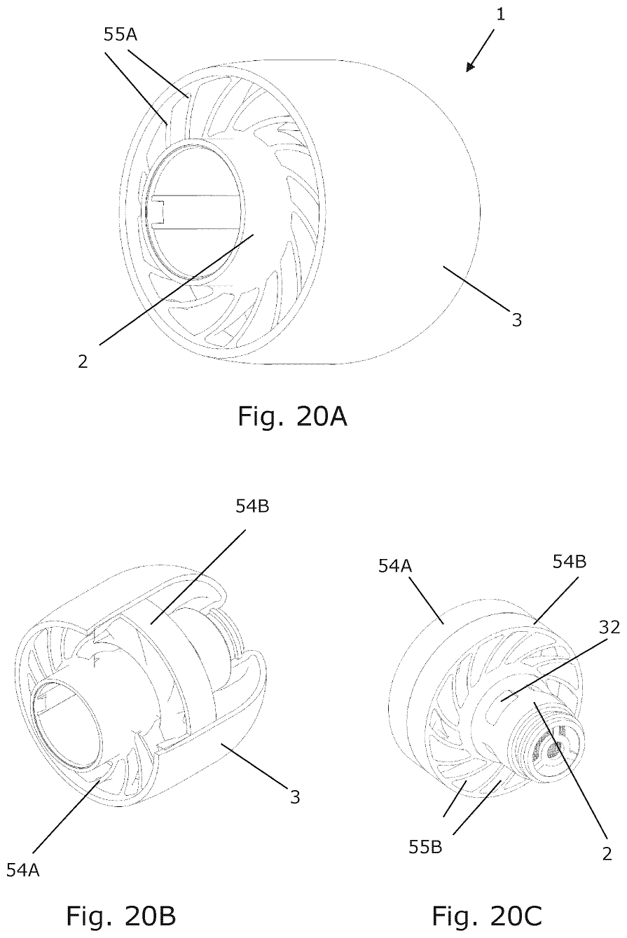

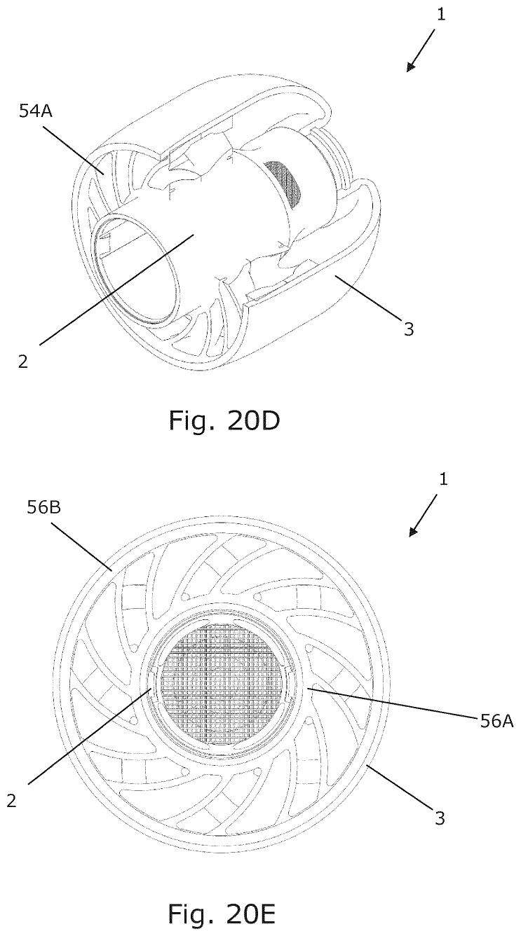

FIGS. 20A-20E illustrates different views of a dome 1 comprising a barrier member 50 which is arranged in the cavity 11.

The illustrated barrier member 50 comprises a first barrier 54A and a second barrier 54B (see FIG. 20C). The first and second barriers 54A, 54B are both arranged circumferentially around the central portion 2 and extend transverse to the longitudinal direction from the outer surface of the central portion 2 to the inner surface of the circumferential member 3. The first and second barriers 54A, 54B are arranged longitudinally offset from each other in the cavity 11.

The first barrier 54A comprises a plurality of first ribs 55A extending outwardly from the central portion 2 at a first angle, whereas the second barrier 54A comprises a plurality of second ribs 55B extending outwardly from the central portion 2 at a second angle, where the first and second angle are different from each other so that a first ribs 55A cross second ribs 55B (see FIG. 20E).

The first and second barriers 54A, 54B are arranged closer to the rear end 9 than the front end 8 to limit wax ingress deeper into the cavity 11. The first and second barriers 54A, 54B are arranged in contact with each other. A front side of the first barrier 54A is in contact with a rear side of the second barrier 54B, where the first barrier 54A is positioned closer to the rear end 9 of the circumferential member 3 than the second barrier.

A first end of each of the ribs 55A, 55B is attached to a base element 56A which is in contact with the central portion 2 (see FIG. 20E). A second base element 56B is arranged along the inner surface of the circumferential member 3. A second end opposite to the first end of each of the ribs 55A, 55B is attached to the second base element 56B. The ribs and the base elements may be moulded in one part.

In the illustrated embodiment, the first and second ribs 55A, 55B are curve shaped, and each of the first ribs 55A are identical, and each of the second ribs 55B are identical. Furthermore, the first barrier 54A and the second barrier 54B are substantially identical, where the different angles of the first and second ribs are achieved by mirroring the second barrier.

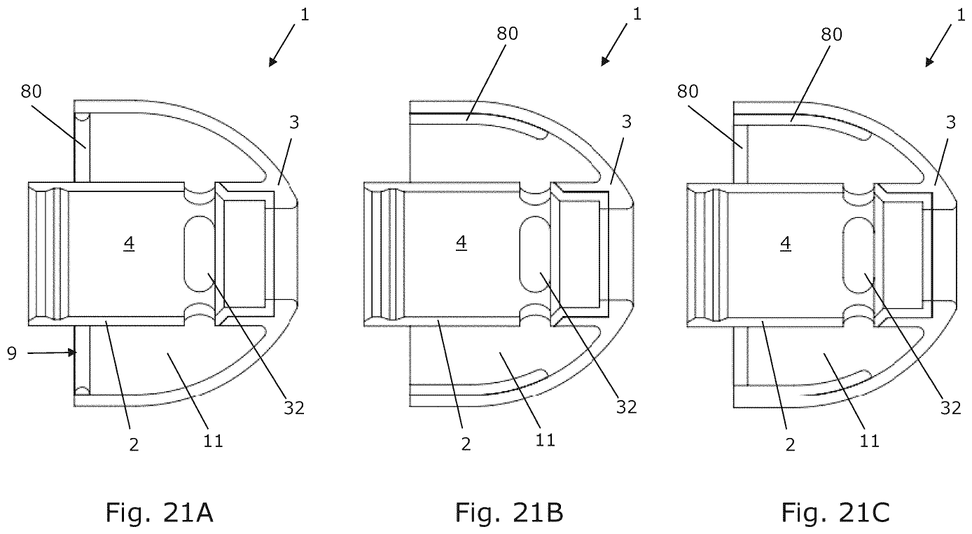

FIGS. 21A-21C illustrate different embodiments of a dome 1 comprising one or more stiffening ribs 80 arranged to prevent buckling of the circumferential member 3. The stiffening rib(s) 80 is(are) arranged along the inner surface 13 of the circumferential member 2 to increase the stiffness of the circumferential member.

In the embodiment illustrated in FIG. 21A, the stiffening rib 80 is arranged circumferentially along the inner surface 13 of circumferential member 2 at the rear end 9. The stiffening rib 80 extend from the inner surface 13 and terminates at the outer surface 12 of the central portion 2.

In the embodiment illustrated in FIG. 21B, a plurality of stiffening ribs 80 are arranged along the inner surface 13 extending from the rear end 9 towards the front end 8 substantially in the longitudinal direction, only two stiffening ribs 80 are shown in the cross-section.

In the embodiment illustrated in FIG. 21C, a stiffening rib 80 is arranged circumferentially along the inner surface 13 of circumferential member 2 at the rear end 9 and a plurality of stiffening ribs 80 are arranged along the inner surface 13 extending from the rear end 9 towards the front end 8.

The stiffening ribs are made of a flexible material to allow the circumferential member 3 to adapt to the shape of the ear canal and to facilitate insertion and removal of the dome 1.

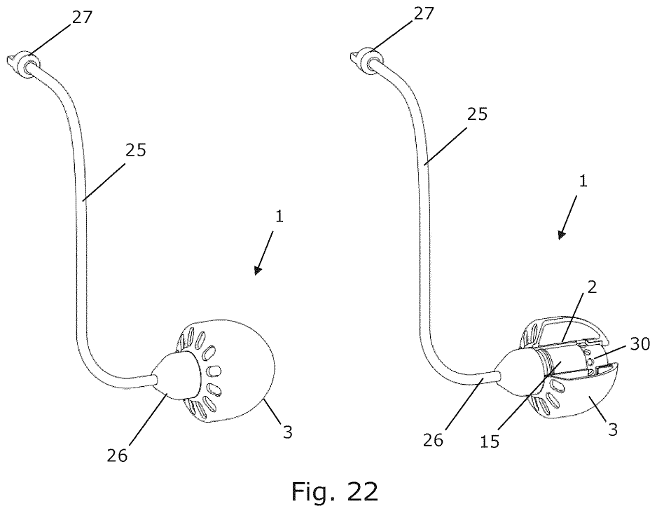

FIG. 22 illustrates different views of a dome 1 comprising a valve 30 and a personal audio device 15 in the form of a receiver.

The circumferential member 3 is attached to the central portion 2 at the first end. The circumferential member 3 is at the rear end folded and attached to the second end of the central portion 2 by gluing, thereby forming an encased dome structure. The encased structure prevents that the rear part of the circumferential member 3 is turned inside out.

Additionally, the attachment of the circumferential member 3 at the rear end provides protection against wax ingress. In the illustrated embodiment, the circumferential member is moulded out of silicone, which allow deformation of the circumferential member 3 and thereby facilitates insertion and removal of the dome to and from the ear canal.

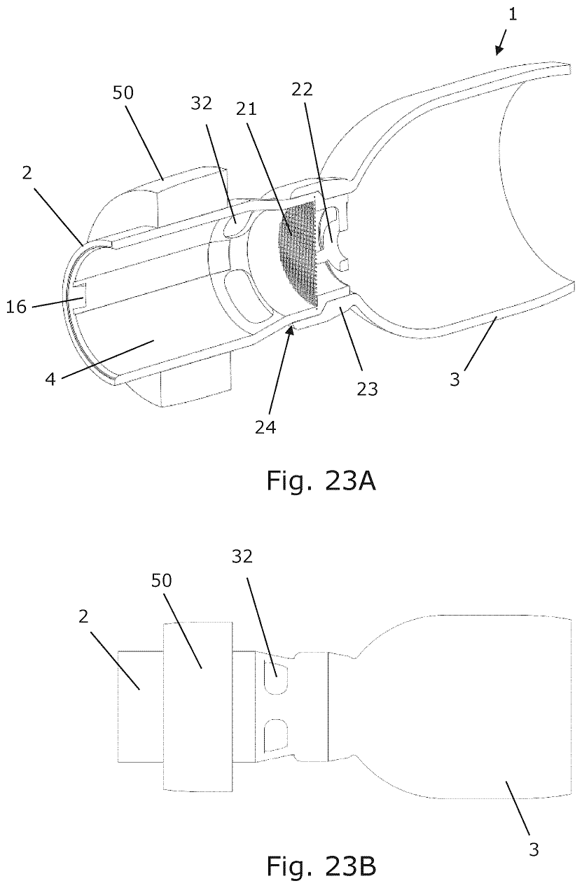

FIG. 23A illustrates a cross-section of a dome 1 comprising a central portion 2, a circumferential member 3, and a barrier member 50 comprising a foam arranged in the cavity 11. FIG. 23B illustrates the dome 1 from the outside. FIG. 23A illustrated how the circumferential member 3 may be attached to the central portion 2 in an inverted state (inside out).

The circumferential member 3 comprises a collar member 23 formed by a wall portion extending from the inner surface of the circumferential member 3 and terminating in a free end 23. The collar member 23 extends parallel to the longitudinal direction to form a space into which the first end 5 of the central portion 2 is inserted and fixed. After insertion of the central portion 2 into the space formed by the collar member 23, the circumferential member 3 is turned so that the inner side faces the outer surface of the central portion 2 whereby the collar 23 extends into the cavity 11. The inner surface of the circumferential member 3 may be glued to the barrier member 50.

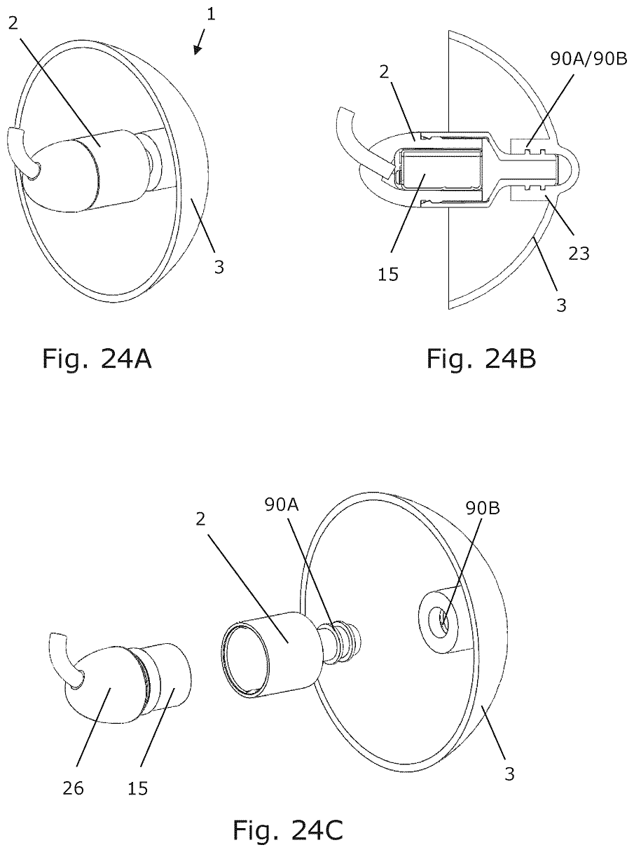

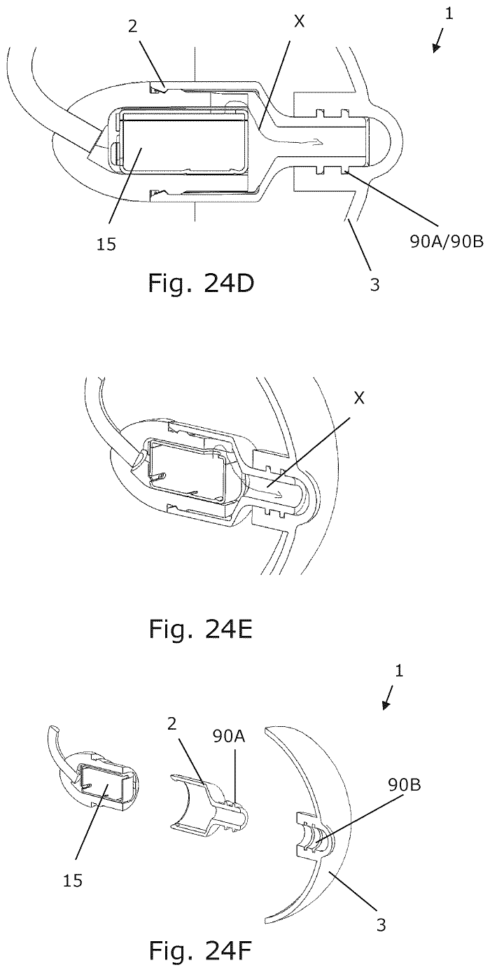

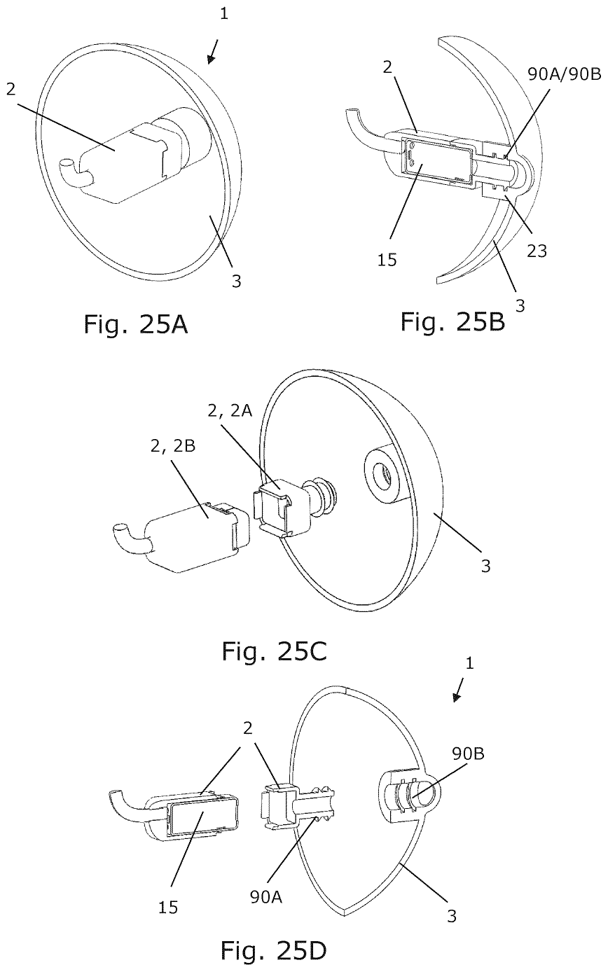

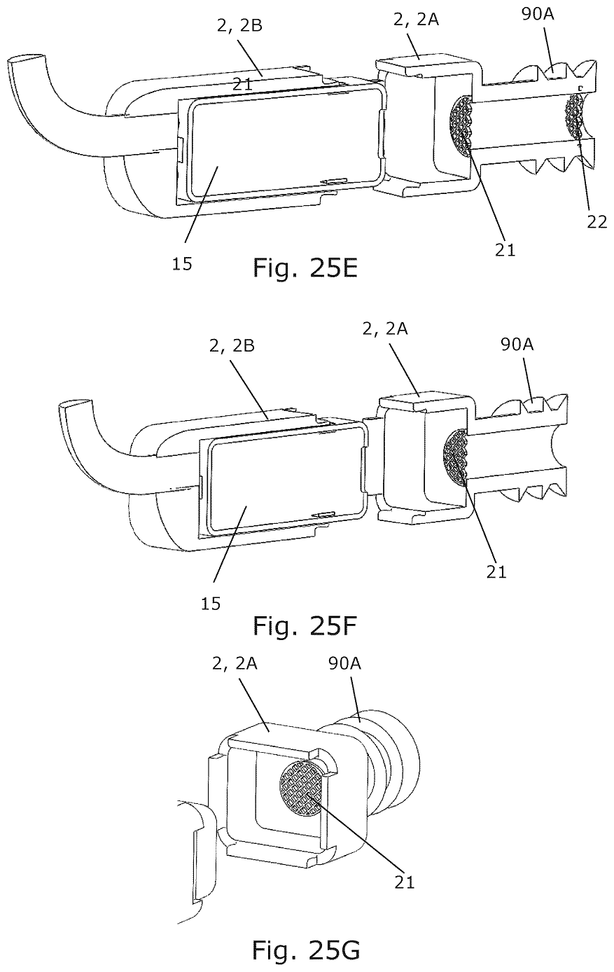

FIGS. 24A-24F and FIGS. 25A-25G illustrate different views of a dome 1 and a personal audio device 15 in the form of a receiver, where the central portion 2 and the circumferential member 3 each comprises an attachment structure 90A, 90B for releasable attachment of the circumferential member 3 to the central portion 2.

In the illustrated embodiments, the central portion 2 comprises two ribs 90A extending outwardly from the outer surface at a position close to the first end 5. The circumferential member 3 comprises two indentations 90B on an inner surface of the collar member 23. Both the ribs 90A and the indentations 90B are arranged substantially perpendicular to the longitudinal direction. When the central portion 2 is inserted in the space formed by the collar member 23, the ribs 90A are inserted into the indentations 90B. Insertion of the central portion 2 into the space is facilitated by the circumferential portion 3 being formed by a second material being more flexible that the first material of which the central portion 2 is made.

In FIGS. 24D and 24E a sound path from the receiver 15 towards an ear canal is illustrated by the arrow X. FIGS. 24F and 25D illustrate a cross-sectional view of the dome 1 with the receiver 15 along the longitudinal direction.

In the embodiment illustrated FIGS. 25A-25G, the central portion 2 is formed by a relatively short first part 2A and a longer second part 2B. In the cross-sectional views, the receiver 15 is arranged in the second part 2B. When the first and second part 2A, 2B are attached to each other, the receiver 15 is fully enclosed by the central portion 2.

1. A dome for a personal audio device, the dome comprising:
a central portion defining a channel extending in a longitudinal direction between a first end and an opposite second end, wherein a first sound opening is arranged at the first end, the first sound opening being configured for passage of sound,
a circumferential member arranged circumferentially around the central portion, the circumferential member being attached to the central portion at the first end, and extending in the longitudinal direction between a front end and a rear end, wherein a second sound opening is arranged at the front end, the second sound opening being configured for passage of sound,
a cavity formed along at least a part of an outer surface of the central portion and at least a part of an inner surface of the circumferential member along the longitudinal direction,
a first sound path arranged in the channel, the first sound path being configured for passage of sound from the personal audio device to an ear canal of a user via the first and second sound openings,
wherein the central portion is formed by a first material and the circumferential member is formed by a second material, the second material being more flexible than the first material, and
wherein a first length of the circumferential member from the front end to the rear end in the longitudinal direction is in the range of 25% to less than 100% of a second length of the central portion from the first end to the second end in the longitudinal direction.

2. A dome according to claim 1, wherein the central portion comprises an engagement structure configured for releasably locking the personal audio device to the dome, when inserted into the channel.

3. A dome according to claim 2, wherein the engagement structure is arranged in the channel, the engagement structure having a shape matching a shape of a part of an outer surface of the personal audio device for mechanical locking of the personal audio device in the channel.

4. A dome according to claim 2, wherein the engagement structure is arranged closer to the second end than the first end.

5. A dome according to claim 1, wherein a support element is arranged at least partly circumferentially around the central portion to support the circumferential member along a portion of an inner surface of the circumferential member between the front end and the rear end.

6. A dome according to claim 1, further comprising a barrier member arranged in the cavity, the barrier member being configured to limit ingress of wax into the cavity by providing hinderance elements in the cavity.

7. A dome according to claim 6, wherein the barrier member comprises a first barrier and a second barrier, the first and second barriers each being arranged circumferentially around the central portion and extending transverse to the longitudinal direction from an outer surface of the central portion to an inner surface of the circumferential member, the first and second barriers being arranged longitudinally offset from each other in the cavity, wherein the first barrier comprises a plurality of first ribs extending outwardly from the central portion at a first angle, and the second barrier comprises a plurality of second ribs extending outwardly from the central portion at a second angle, the first and second angle being different from each other.

8. A dome according to claim 1, wherein at least one sound aperture is arranged in the central portion at a distance from the first end, the at least one sound aperture being configured for passage of sound between the channel and the cavity.

9. A dome according to claim 8, wherein the at least one sound aperture is arranged to at least partly overlap with a valve opening in a valve arranged in the channel to allow sound passage between the channel and the cavity via the valve, the valve forming a second sound path configured for passage of sound to and from the ear canal.

10. A dome according to claim 1, wherein a protection element is arranged at the first sound opening to limit ingress of wax into the channel.

11. A dome according to claim 10, wherein an additional protection element is arranged longitudinally off-set to the protection element, the protection element being closer to the first sound opening than the additional protection element.

12. A dome according to claim 10, wherein a permeability of the additional protection element is greater than a permeability of the protection element.

13. A dome according to claim 10, wherein the protection element is formed integrally with the central portion.

14. A dome according to claim 1, wherein the circumferential member comprises a collar member, the collar member extending into the cavity and terminating in a free end, the collar member having a shape matching an outer shape of a part of the central portion for attachment of the circumferential member to the central portion.

15. A dome according to claim 1, wherein at least one stiffening rib is arranged along an inner surface of the circumferential member to increase the stiffness of the circumferential member.

16. A dome according to claim 1, wherein at least one connection element is arranged at the rear end, the connection element connecting the circumferential member to the central portion.

17. A dome according to claim 1, wherein the circumferential member is attached to the central portion by gluing or moulding.

18. A dome for a personal audio device, the dome comprising:
a central portion defining a channel extending in a longitudinal direction between a first end and an opposite second end, wherein a first sound opening is arranged at the first end, the first sound opening being configured for passage of sound,
a circumferential member arranged circumferential around the central portion, the circumferential member being attached to the central portion at the first end, and extending in the longitudinal direction between a front end and a rear end, wherein a second sound opening is arranged at the front end, the second sound opening being configured for passage of sound,
a cavity formed along at least a part of an outer surface of the central portion and at least a part of an inner surface of the circumferential member along the longitudinal direction,
a first sound path arranged in the channel, the first sound path being configured for passage of sound from the personal audio device to an ear canal of a user via the first and second sound openings,
wherein the central portion is formed by a first material and the circumferential member is formed by a second material, the second material being more flexible than the first material, and
wherein the central portion comprises an engagement structure configured for releasably locking the personal audio device to the dome, when inserted into the channel, the central portion being configured to accommodate at least 50% of the personal audio device in the channel.

19. A hearing device comprising a dome according to claim 1 and a personal audio device.
